(19) United States
(12) Patent Application Publication
(10) Pub. No.: US 2024/0153512 A1
(43) Pub. Date: May 9, 2024

(54) AUDIO CODEC WITH ADAPTIVE GAIN CONTROL OF DOWNMIXED SIGNALS

(71) Applicants: Dolby Laboratories Licensing Corporation, San Francisco, CA (US); DOLBY INTERNATIONAL AB, Dublin (IE)

(72) Inventors: Panji Setiawan, Munich (DE); Rishabh Tyagi, Sydney, NSW (AU); Stefan Bruhn, Sollentuna (SE)

(73) Assignees: Dolby Laboratories Licensing Corporation, San Francisco, CA (US); DOLBY INTERNATIONAL AB, Dublin (IE)

(21) Appl. No.: 18/548,817

(22) PCT Filed: Mar. 8, 2022
(86) PCT No.: PCT/US2022/019292

§ 371 Date: Sep. 1, 2023

Related U.S. Application Data
(60) Provisional application No. 63/267,878, filed on Feb. 11, 2022.
(60) Provisional application No. 63/161,868, filed on Mar. 16, 2021.
(60) Provisional application No. 63/159,807, filed on Mar. 11, 2021.

(51) Int. Cl. G10L 19/008; G10L 19/005

(52) U.S. Cl. CPC G10L 19/008; G10L 19/005; G10L 19/002

(57) ABSTRACT

A method for performing gain control on audio signals is provided. In some implementations, the method involves determining downmixed signals associated with one or more downmix channels associated with a current frame of an audio signal to be encoded. In some implementations, the method involves determining whether an overload condition exists for an encoder. In some implementation, the method involves determining a gain parameter. In some implementations, the method involves determining at least one gain transition function based on the gain parameter and a gain parameter associated with a preceding frame of the audio signal. In some implementations, the method involves applying the at least one gain transition function to one or more of the downmixed signals. In some implementations, the method involves encoding the downmixed signals in connection with information indicative of gain control applied to the current frame.

### CROSS-REFERENCE TO RELATED APPLICATIONS

This application claims the benefit of U.S. Provisional Patent Application No. 63/159,807 filed 11 Mar. 2021; U.S. Provisional Application No. 63/161,868 filed 16 Mar. 2021, and U.S. Provisional Application No. 63/267,878 filed 11 Feb. 2022, which are incorporated herein by reference.

### TECHNICAL FIELD

This disclosure pertains to systems, methods, and media for adaptive gain control.

### BACKGROUND

Gain control may be used, for example, to attenuate signals to be within a range expected by a core codec. Many gain control techniques to determine a gain to be applied require a delay and/or depend on gain parameters applied to previous frames. Such gain control techniques may cause issues when utilized in situations that are error-prone, such as cellular transmissions, and/or require real-time processing, such as conversations.

### NOTATION AND NOMENCLATURE

Throughout this disclosure, including in the claims, the terms “speaker,” “loudspeaker” and “audio reproduction transducer” are used synonymously to denote any sound-emitting transducer or set of transducers. A typical set of headphones includes two speakers. A speaker may be implemented to include multiple transducers, such as a woofer and a tweeter, which may be driven by a single, common speaker feed or multiple speaker feeds. In some examples, the speaker feed(s) may undergo different processing in different circuitry branches coupled to the different transducers.

Throughout this disclosure, including in the claims, the expression performing an operation “on” a signal or data, such as filtering, scaling, transforming, or applying gain to, the signal or data, is used in a broad sense to denote performing the operation directly on the signal or data, or on a processed version of the signal or data. For example, the operation may be performed on a version of the signal that has undergone preliminary filtering or pre-processing prior to performance of the operation thereon.

Throughout this disclosure including in the claims, the expression “system” is used in a broad sense to denote a device, system, or subsystem. For example, a subsystem that implements a decoder may be referred to as a decoder system, and a system including such a subsystem (e.g., a system that generates X output signals in response to multiple inputs, in which the subsystem generates M of the inputs and the other X-M inputs are received from an external source) may also be referred to as a decoder system.

Throughout this disclosure including in the claims, the term “processor” is used in a broad sense to denote a system or device programmable or otherwise configurable, such as with software or firmware, to perform operations on data, which may include audio, or video or other image data. Examples of processors include a field-programmable gate array (or other configurable integrated circuit or chip set), a digital signal processor programmed and/or otherwise configured to perform pipelined processing on audio or other sound data, a programmable general purpose processor or computer, and a programmable microprocessor chip or chip set.

### SUMMARY

At least some aspects of the present disclosure may be implemented via methods. Some methods may involve determining downmixed signals associated with one or more downmix channels associated with a current frame of an audio signal to be encoded. Some methods may involves determining whether an overload condition exists for an encoder to be used to encode the downmixed signals for at least one of the one or more downmix channels. Some methods may involve responsive to determining that the overload condition exists, determining a gain parameter for the at least one of the one or more downmix channels for the current frame of the audio signal. Some methods may involve determining at least one gain transition function based on the gain parameter and a gain parameter associated with a preceding frame of the audio signal. Some methods may involve applying the at least one gain transition function to one or more of the downmixed signals. Some methods may involve encoding the downmixed signals in connection with information indicative of gain control applied to the current frame.

In some examples, the at least one gain transition function is determined using a partial frame buffer. In some examples, determining the at least one gain transition function using the partial frame buffer introduces substantially 0 additional delay.

In some examples, the at least one gain transition function comprises a transitory portion and a steady-state portion, and wherein the transitory portion corresponds to a transition from the gain parameter associated with the preceding frame of the audio signal to the gain parameter associated with the current frame of the audio signal. In some examples, the transitory portion has a transitory type of fade in which gain increases over a portion of samples of the current frame responsive to an attenuation associated with the gain parameter of the preceding frame being greater than an attenuation associated with the gain parameter of the current frame. In some examples, the transitory portion has a transitory type of reverse fade in which gain decreases over a portion of samples of the current frame responsive to an attenuation associated with the gain parameter of the preceding frame being less than an attenuation associated with the gain parameter of the current frame. In some examples, the transitory portion is determined using a prototype function and a scaling factor, and wherein the scaling factor is determined based on the gain parameter associated with the current frame and the gain parameter associated with the preceding frame. In some examples, the information indicative of the gain control applied to the current frame comprises information indicative of the transitory portion of the at least one gain transition function.

In some examples, the at least one gain transition function comprises a single gain transition function applied to all of the one or more downmix channels for which the overload condition exists. In some examples, the at least one gain transition function comprises a single gain transition function applied to all of the one or more downmix channels, and wherein the overload condition exists for a subset of the one or more downmix channels. In some examples, the at least one gain transition function comprises a gain transition function for each of the one or more downmix channels for which the overload condition exists. In some examples, a number of bits used to encode the information indicative of the gain control applied to the current frame scales substantially linearly, with a number of downmix channels for which the overload condition exists.

In some examples, some methods may further involve: determining second downmixed signals associated with the one or more downmix channels associated with a second frame of the audio signal to be encoded; determining whether an overload condition exists for the encoder for at least one of the one or more downmix channels for the second frame; and responsive to determining that the overload condition does not exist for the second frame, encoding the second downmixed signals without applying a non-unity gain. In some examples, some methods may further involve setting a flag indicating that gain control is not applied to the second frame, wherein the flag comprises one bit.

In some examples, some methods may further involve determining a number of bits used to encode the information indicative of the gain control applied to the current frame; and allocating the number of bits from: 1) bits used to encode metadata associated with the current frame; and/or 2) bits used to encode the downmixed signals for encoding of the information indicative of the gain control applied to the current frame. In some examples, the number of bits are allocated from bits used to encode the downmixed signals, and wherein the bits used to encode the downmixed signals are decreased in an order based on spatial directions associated with the one or more downmixed channels.

Some methods may involve receiving, at a decoder, an encoded frame of an audio signal for a current frame of the audio signal. Some methods may involve decoding the encoded frame of the audio signal to obtain downmixed signals associated with the current frame of the audio signal and information indicative of gain control applied to the current frame of the audio signal by an encoder. Some methods may involve determining an inverse gain function to be applied to one or more downmixed signals associated with the current frame of the audio signal based at least in part on the information indicative of the gain control applied to the current frame of the audio signal. Some methods may involve applying the inverse gain function to the one or more downmixed signals. Some methods may involve upmixing the downmixed signals to generate upmixed signals, including the one or more downmixed signals to which the inverse gain function was applied, wherein the upmixed signals are suitable for rendering.

In some examples, the information indicative of the gain control applied to the current frame comprises a gain parameter associated with the current frame of the audio signal. In some examples, the inverse gain function is determined based at least in part on the gain parameter for the current frame of the audio signal and a gain parameter associated with a preceding frame of the audio signal.

In some examples, the inverse gain function comprises a transitory portion and a steady-state portion.

In some examples, some methods may further involve determining, at the decoder, that a second encoded frame has not been received; reconstructing, by the decoder, a substitute frame to replace the second encoded frame; and applying inverse gain parameters applied to a preceding encoded frame that preceded the second encoded frame to the substitute frame. In some examples, some methods may further involve: receiving, at the decoder, a third encoded frame that is subsequent to the second encoded frame; decoding the third encoded frame to obtain downmixed signals associated with the third encoded frame and information indicative of gain control applied to the third encoded frame by the encoder; and determining inverse gain parameters to be applied to the downmixed signals associated with the third encoded frame by smoothing the inverse gain parameters applied to the substitute frame with inverse gain parameters associated with the gain control applied to the third encoded frame by the encoder. In some examples, some methods may further involve: receiving, at the decoder, a third encoded frame that is subsequent to the second encoded frame; decoding the third encoded frame to obtain downmixed signals associated with the third encoded frame and information indicative of gain control applied to the third encoded frame by the encoder; and determining inverse gain parameters to be applied to the downmixed signals associated with the third encoded frame such that the inverse gain parameters implement a smooth transition in gain parameters from the third encoded frame. In some examples, there is at least one intermediate frame between the second encoded frame that was not received and the third encoded frame that was received, and wherein the at least one intermediate frame was not received at the decoder. In some examples, some methods may further involve: receiving, at the decoder, a third encoded frame that is subsequent to the second encoded frame; decoding the third encoded frame to obtain downmixed signals associated with the third encoded frame and information indicative of gain control applied to the third encoded frame by the encoder; and determining inverse gain parameters to be applied to the downmixed signals associated with the third encoded frame based at least in part on inverse gain parameters applied to a frame received at the decoder that preceded the second encoded frame that was not received at the decoder. In some examples, some methods may further involve receiving, at the decoder, a third encoded frame that is subsequent to the second encoded frame; decoding the third encoded frame to obtain downmixed signals associated with the third encoded frame and information indicative of gain control applied to the third encoded frame by the encoder; and re-scaling an internal state of the decoder based on the information indicative of the gain control applied to the third encoded frame.

In some examples, some methods may further involve rendering the upmixed signals to produce rendered audio data. In some examples, some methods may further involve playing back the rendered audio data using one or more of: a loudspeaker or headphones.

Some or all of the operations, functions and/or methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented via one or more non-transitory media having software stored thereon.

At least some aspects of the present disclosure may be implemented via an apparatus. For example, one or more devices may be capable of performing, at least in part, the methods disclosed herein. In some implementations, an apparatus is, or includes, an audio processing system having an interface system and a control system. The control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a schematic block diagram of a system for providing gain control of audio signals in accordance with some embodiments.

FIG. 2 is a schematic block diagram of a system for implementing adaptive gain control in accordance with some embodiments.

FIGS. 3A and 3B show examples of gain functions that may be implemented by an encoder and inverse gain functions that may be implemented by a decoder, respectively, in accordance with some embodiments.

FIG. 4 shows example graphs of inverse gains that may be applied by a decoder responsive to dropped frames in accordance with some embodiments.

FIG. 5 is a flowchart of an example process that may be performed by an encoder for implementing adaptive gain control in accordance with some embodiments.

FIG. 6 is a flowchart of an example process that may be performed by a decoder for implementing adaptive gain control in accordance with some embodiments.

FIG. 7A is an example schematic diagram of an encoder and decoder that utilize spatial reconstruction encoding techniques in accordance with some embodiments.

FIG. 7B is a block diagram of an example multi-channel codec that utilizes adaptive gain control in accordance with some embodiments.

FIG. 8 is a flowchart of an example process for bit distribution in implementation of adaptive gain control in accordance with some embodiments.

FIG. 9 illustrates example use cases for an Immersive Voice and Services (IVAS) system in accordance with some embodiments.

FIG. 10 shows a block diagram that illustrates examples of components of an apparatus capable of implementing various aspects of this disclosure.

Like reference numbers and designations in the various drawings indicate like elements.

### DETAILED DESCRIPTION OF EMBODIMENTS

Some coding techniques for scene-based audio, stereo audio, multi-channel audio, and/or object audio rely on coding multiple component signals after a downmix operation. Downmixing may allow a reduced number of audio components to be coded in a waveform encoded manner that retains the waveform, and the remaining components may be encoded parametrically. On the receiver side, the remaining components may be reconstructed using parametric metadata indicative of the parametric encoding. Because only a subset of the components are waveform encoded and the parametric metadata associated with the parametrically encoded components may be encoded efficiently with respect to bit rate, such a coding technique may be relatively bit rate efficient while still allowing high quality audio.

One problem that may occur is that downmix channels determined by a spatial encoder may include signals with levels that are not suitable for subsequent processing by a core codec that constructs an audio signal bitstream. For example, in some cases, a downmix signal may have a level that is so high that the core codec is overloaded despite the original input signal not being overloaded in any of its component signals. This may cause severe distortions such as clipping in the reconstructed signal after decoding and rendering. This may cause substantial quality loss in the ultimately rendered signals. One potential solution may be to attenuate the input signal to avoid overloading of the core codec. However, this solution may have the drawback of increasing granular noise, because quantizers utilized to encode the signal may not be operating in an optimal range.

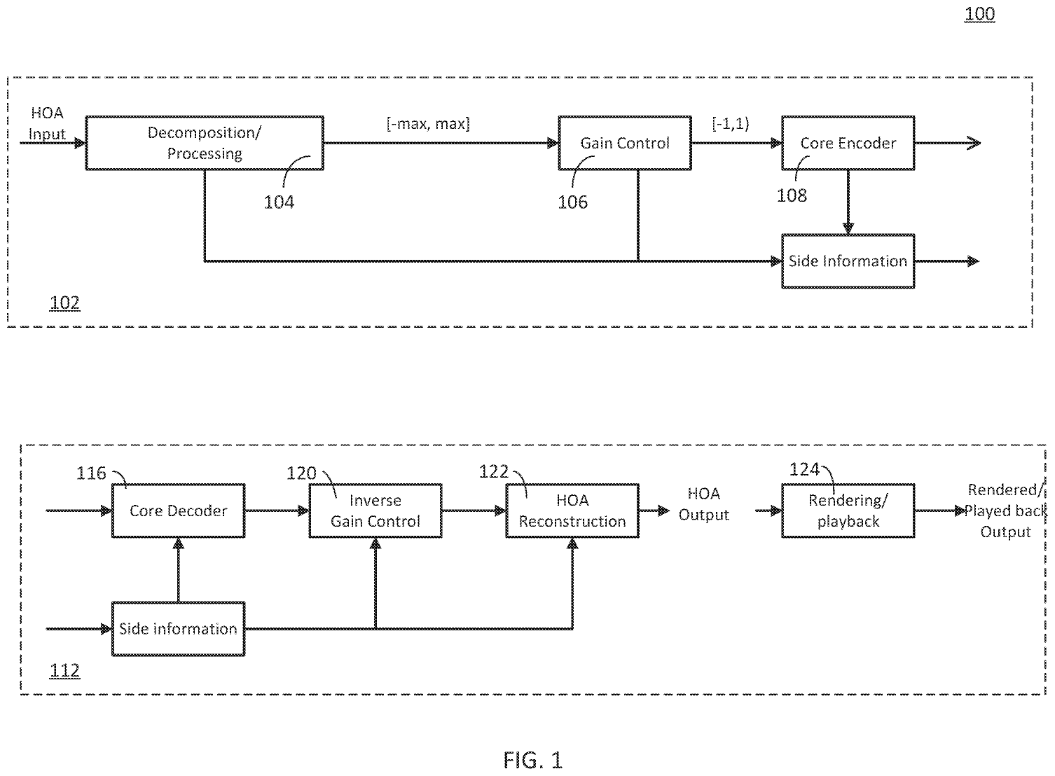

FIG. 1 shows a schematic block diagram of a conventional system for performing gain control on encoded higher order Ambisonics (HOA) signals. The schematic diagram shown in FIG. 1 may be used for encoding and decoding MPEG-H signals. MPEG-H is a group of international standards under development by the International Organization for Standardization (ISO)/International Electrotechnical Commission (IEC) Moving Picture Experts Group (MPEG). MPEG-H has various parts, including Part 3, MPEG-H 3D Audio. It should be noted that, because MPEG-H audio is a codec not designed for conversational applications in error-prone transmission environments such as cellular communications, the MPEG-H audio codec need not satisfy strict coding latency requirements and/or strict transmission error resilience requirements. The gain control thus applied may therefore utilize recursive operations and may introduce a delay, as will be discussed in more detail below.

At an encoder 102, an input HOA signal is processed at 104. The processing may include decomposition, for example, in which downmix channels are generated. The downmix channels may include a set of signals which are bound by [−max, max] for a given frame. Because a core encoder 108 can encode signals within a range of [−1, 1), samples of the signals associated with the downmix channels that exceed the range of core encoder 108 may cause overload. To avoid overload, a gain control 106 adjusts the gain of the frame such that the associated signals are within the range of core encoder 108 (e.g., within [−1, 1)). Core encoder 108 may be considered the codec that generates an encoded bitstream. Side information generated by the decomposition/processing block 104, which may include metadata associated with parametrically encoded channels, or the like, may be encoded in a bitstream in connection with the signals produced as an output of core encoder 108.

The encoded bitstream is received by a decoder 112. Decoder 112 may extract the side information and a core decoder 116 may extract downmix signals. An inverse gain control block 120 may then reverse the gain applied by the encoder. For example, the inverse gain control block 120 may amplify signals that were attenuated by gain control 106 of encoder 102. The HOA signals may then be reconstructed by an HOA reconstruction block 122. Optionally, the HOA signals may be rendered and/or played back by rendering/playback block 124. Rendering/playback block 124 may include, for example, various algorithms for rendering the reconstructed HOA output, e.g., as rendered audio data. For example, rendering the reconstructed HOA output may involve distributing the one or more signals of the HOA output across multiple speakers to achieve a particular perceptual impression. Optionally, rendering/playback block 124 may include one or more loudspeakers, headphones, etc. for presenting the rendered audio data.

Gain control 106 may implement gain control using the following techniques. Gain control 106 may first determine an upper bound of the signal values in a frame. For example, for MPEG-H audio signals, the bound may be expressed as a product \sqrt{Kₘₐₓ}*0, where the product is specified in the MPEG-H standard. Given the upper bound, the minimum attenuation required may ensure that the scaled signal samples are bound by the interval [−1, 1). In other words, the scaled samples may be within the range of core encoder 108. This may be determined by applying the gain factor of 2^{-|e}^{ₘᵢₙ}^{|}, where |eₘᵢₙ|=ceil(log₂(\sqrt{Kₘₐₓ}*0)). By definition, eₘᵢₙ may be a negative number. In some embodiments, amplification may be limited by a maximum amplification factor 2^{e}^{ₘₐₓ}, where eₘₐₓ is a non-negative integer number. Accordingly, to perform both attenuation and amplification, a gain factor of 2^{e} can be defined, with the gain parameter e being a value in the range of [eₘᵢₙ, eₘₐₓ]. Consequently, the lowest number of bits required to represent the gain parameter e is determined as βₑ=ceil(log₂(|eₘᵢₙ|+eₘₐₓ+1)).

As described above, a gain factor gₙ(j), for a particular channel n and frame j may be determined by applying a one frame delay, which corresponds to one HOA block, and utilizing the following recursive operation:

gₙ(j−1)=gₙ(j−2)*2^{e}^{ₙ}^{(j-1)}

In the above, gₙ(j−2) represents a gain factor applied for the frame (j−2), and 2^{e}^{ₙ}^{(j-1)} represents the gain factor adjustment required to calculate the gain factor gₙ(j−1) for the frame j−1. To determine the gain factor adjustment, information is used from the current frame j, which introduces a delay of one frame. In other words, determination of the gain factor using this technique both introduces a one frame delay, and requires a recursive computation.

The requirement of knowledge of the gain gₙ(j−2) may be problematic in the case of potential transmission errors in which there may be a deviation between encoder and decoder states, and thus, the gain may not be accurately reconstructed by the decoder. Moreover, in cases in which encoded content is accessed at a random position, such as other than at the beginning of the file, previous frame information may not be accessible. The drawbacks of conventional gain control that utilize recursive operations and a delay may therefore not be suitable for implementation in codecs that require low-delay and in error-prone environments, such as those utilized for cellular transmissions.

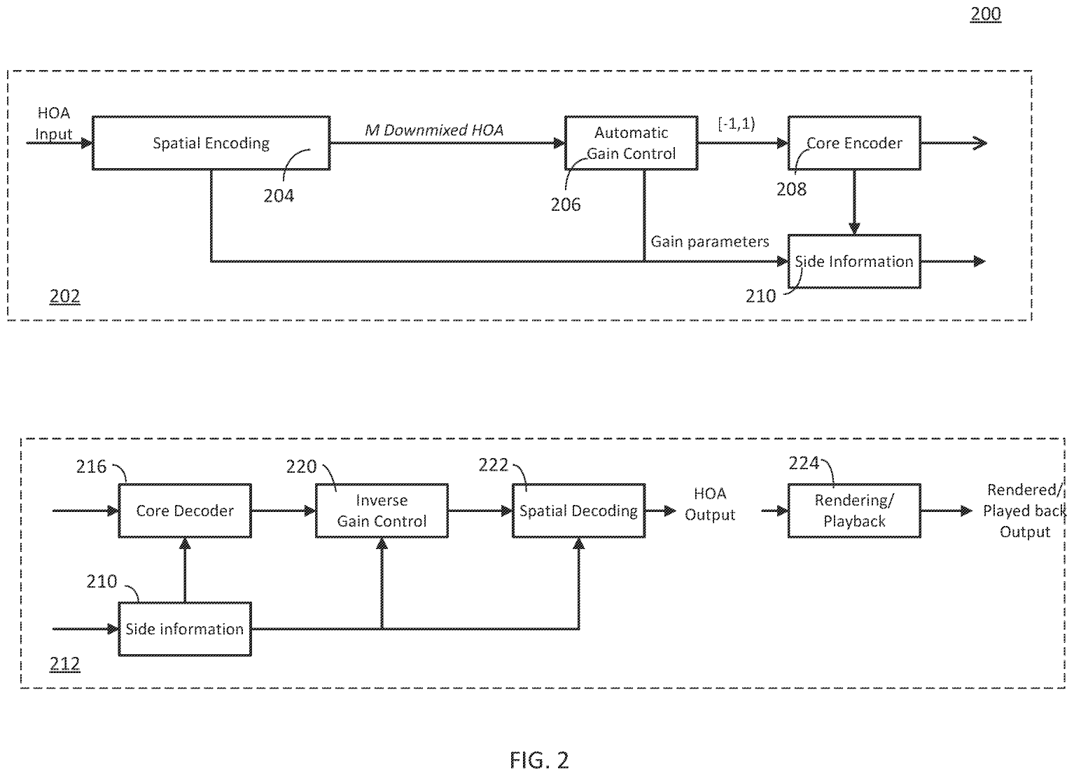

Disclosed herein are techniques for providing adaptive gain control. In particular, as described herein, gain parameters may be determined that have zero delay, because gain parameters may be determined based on lookahead samples generated for use by a codec. It should be noted that the codec may be that used by a perceptual encoder. Moreover, the determined gain parameters may be determined non-recursively, allowing the adaptive gain control techniques to be utilized in error-prone environments in which frames may be dropped. Determination of gain parameters and application of associated gain transition functions are shown in and described below in connection with FIGS. 2-6.

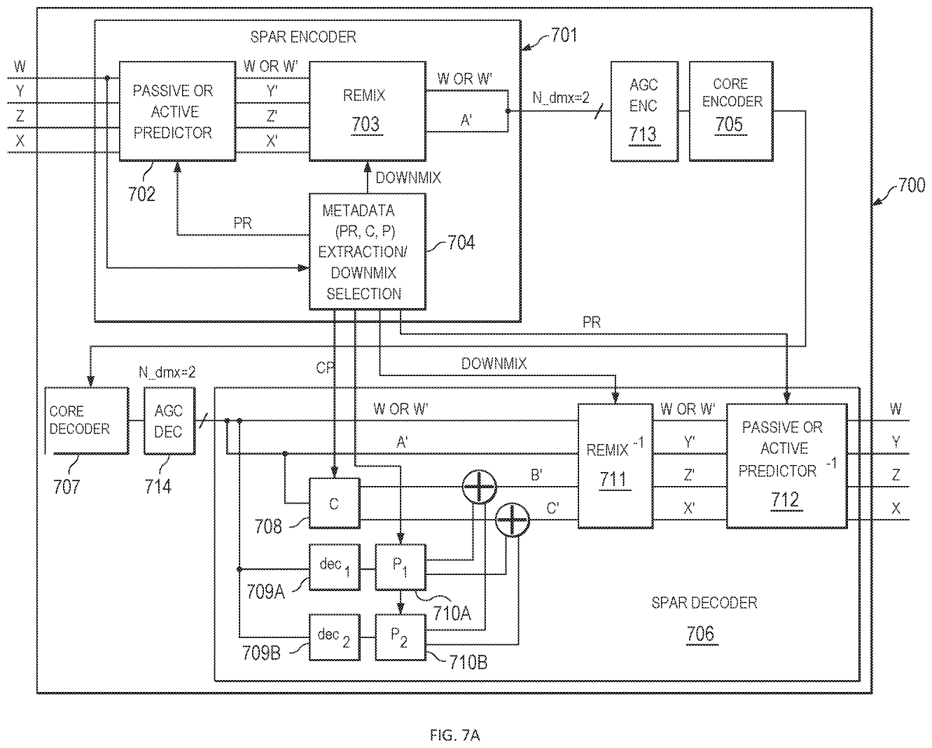

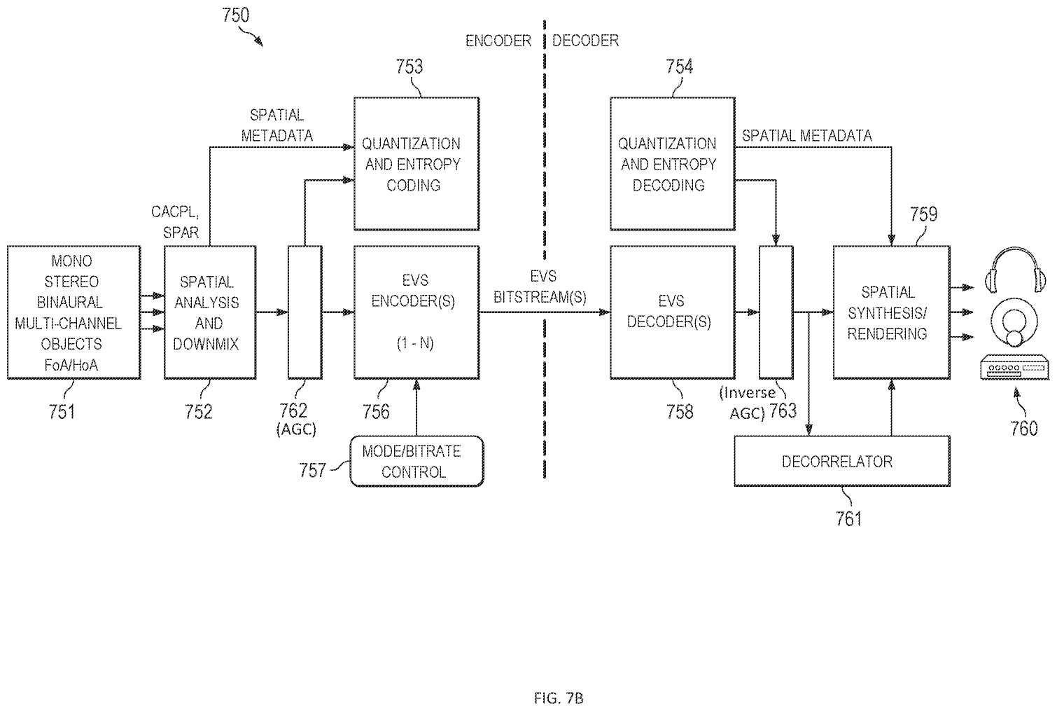

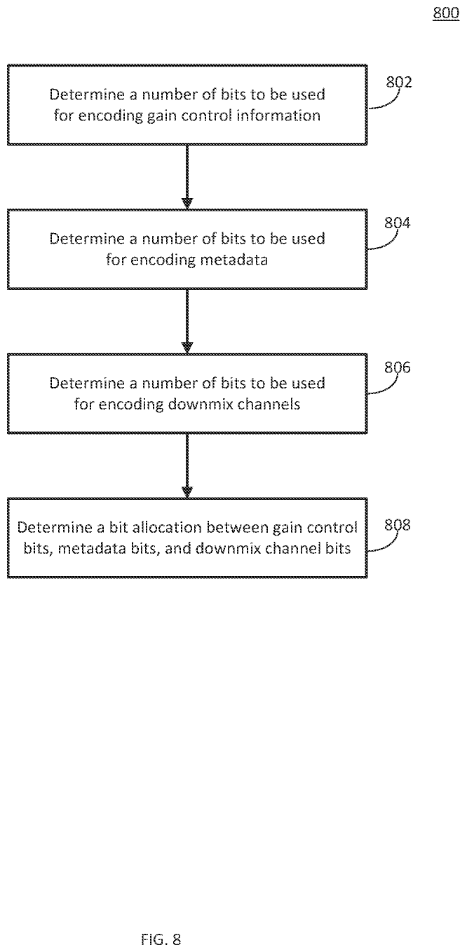

Additionally, in some implementations, adaptive gain control may be applied only in instances in which one or more downmix channels are associated with signals that would cause an overload condition of the codec by exceeding an expected range of the codec. As described herein, in instances in which gain control is not applied, such as in instances in which no overload condition exists, gain parameters may not be encoded for the frame. By selectively encoding gain parameters in instances in which gain control is to be applied, rather than for all frames, the gain control techniques described herein yield a more bitrate efficient encoding. A more efficient encoding of gain parameters allows more bits to be utilized for encoding of downmix channels, ultimately leading to better audio quality. Techniques for allocating bits between those utilized for encoding gain information, those used for encoding metadata, and those used for encoding downmix channels are shown in and described below in connection with FIGS. 7 and 8.

FIG. 2 shows a schematic block diagram of an example system 200 for performing low-delay adaptive gain control in accordance with some embodiments. As illustrated, system 200 includes an encoder 202 and a decoder 212. At encoder 202, an input HOA signal (or first-order Ambisonic (FOA)) signal undergoes processing by a spatial encoding block 204. For an N channel input, spatial encoding block 204 may generate a set of M downmix channels. The number of downmix channels in the set of downmix channels may be in a range of 1-N. For example, for an FOA input, the downmix channels may include a primary downmix channel W, which can be generated by mixing the omnidirectional input signal W with the directional input signals X, Y and Z using a variety of mixing gains, and up to 3 residual channels, X′, Y′, and Z′, each corresponding to signal components in the X, Y, and Z signals that cannot be predicted from the primary downmix signal. In one example, spatial encoding block 204 utilizes the Spatial Reconstruction (SPAR) technique. SPAR is further described in D. McGrath, S. Bruhn, H. Purnhagen, M. Eckert, J. Torres, S. Brown, and D. Darcy Immersive Audio Coding for Virtual Reality Using a Metadata-assisted Extension of the 3GPP EVS Codec IEEE International Conference on Acoustics, Speech and Signal Processing (ICASSP), 2019, pp. 730-734, which is hereby incorporated by reference in its entirety. In other examples, spatial encoding block 204 may utilize any other suitable linear predictive codec of energy compacting transform, such as a Karhunen-Loeve Transform (KLT) or the like. In some implementations, the downmix channels are generated using lookahead samples that are to be utilized by a core encoder 208. In some implementations, spatial encoding block 204 may additionally generate side information 210, which may be utilized by core encoder 208. Side information 210 may include metadata used to upmix the downmixed channels by decoder 212. For example, side information 210 may be utilized to reconstruct a representation of the original audio input that was downmixed by spatial encoding unit 204.

The signals associated with the M downmix channels may then be analyzed by an adaptive gain control 206. Adaptive gain control 206 may determine whether signals associated with any of the M downmix channels surpass the range expected by core encoder 208, and therefore, will overload core encoder 208. In some embodiments, in an instance in which adaptive gain control 206 determines that no gain is to be applied, such as responsive to a determination that none of the signals of the M downmix channels exceed an expected range of core encoder 208, adaptive gain control 206 may set a flag indicating that no gain control is applied. The flag may be set by setting a value of a single bit. It should be noted that, in some implementations, in instances in which adaptive gain control 206 determines that no gain is to be applied, adaptive gain control 206 may not set the flag, thereby, preserving one bit (e.g., the bit associated with the flag). For example, in some implementations, if a spatial metadata bitstream and/or a core encoder bitstream (which may be a perceptual encoder bitstream) are self-terminating, the presence of a gain control flag may be determined by determining whether there are any unread bits in the bitstream. The unread bits may be left over bits in the bitstream. The M downmix channels may then be passed to core encoder 208 for encoding in a bitstream in connection with side information 210.

Conversely, in instances in which adaptive gain control 206 determines that gain is to be applied, adaptive gain control 206 may determine gain parameters and apply gain(s) to the M downmix channels according to the determined gain parameters. The M downmix channels with gain applied may then be passed to core encoder 208 for encoding in a bitstream in connection with side information 210. The gain parameters may be included in side information 210, e.g., as a set of bits that indicate the gain parameters, as described below in more detail.

In some implementations, adaptive gain control 206 may determine a gain to be applied by determining a gain parameter e(j) for a current frame j and for a particular channel of the M downmixed channels that exceeds the expected range of core encoder 208 (e.g., that will cause an overload condition). In some implementations, the gain parameter e(j) is the minimum positive integer (including 0) that causes the signals associated with the channel to be within the expected range when scaling the signals associated with the channel by a gain factor determined based on the gain parameter. As described above, the expected range may be [01, 1]. For example, the gain factor may be 2^{-e(j)}. It should be noted that, in some implementations, rather than identifying a gain parameter that causes the scaled channel to avoid the overload condition, the gain parameter may be selected such that when scaled by the gain factor, the signals are within a range less than that associated with the overload condition. In other words, the gain parameter may be selected such that scaled signals either just avoid the overload condition, or are within some predetermined range less than that associated with the overload condition, for example, to allow some headroom.

In some implementations, adaptive gain control 206 may determine a gain transition function that transitions between a gain parameter e(j−1) associated with a previous frame (e.g., the j−1^{th} frame) and the gain parameter of the current frame, e(j). In some implementations, the gain transition function may smoothly transition the gain parameter across the samples of the j^{th} frame from the value of the gain parameter at the j−1^{th} frame (e.g., e(j−1)) to the gain parameter of the current frame (e.g., e(j)). Accordingly, the gain transition function may include two portions: 1) a transitory portion in which the gain parameter is transitioning across the samples of the transition portion from the gain parameter of the preceding frame to the gain parameter of the current frame; and 2) a steady-state portion in which the gain parameter has the value of the gain parameter of the current frame for the samples of the steady-state portion.

In some embodiments, in an instance in which the gain applied to the current frame is less than the gain applied to the previous frame, the transitory portion may be referred to as having a transitory type of “fade,” because the amount of attenuation increases across the samples of the current frame. The case where the gain applied to the current frame is less than the gain applied to the previous frame may be represented as e(j)>e(j−1). In some embodiments, in an instance in which the gain applied to the current frame is greater than the gain applied to the previous frame, the transitory portion may be referred to as having a transitory type of “reverse fade,” or “un-fade,” because the amount of attenuation decreases across the samples of the current frame. The case where the gain applied to the current frame is greater than the gain applied to the previous frame may be represented as e(j)<e(j−1). In some embodiments, in an instance in which the gain applied to the current frame is the same as the gain applied to the current frame, the transitory portion may be referred to as having a transitory type of “hold,” in which the transitory portion is not transitory and rather has the same value as the steady-state portion. The case where the gain applied to the current frame is the same as the gain applied to the current frame may be represented as e(j)=e(j−1).

In some embodiments, a transitory portion of a gain transition function may be determined using a prototype shape of a transitory part of a gain transition function, where the prototype shape is scaled based on the difference between the gain parameter of the current frame and the gain parameter of the preceding frame. For example, the prototype shape may be scaled based on e(j)−e(j−1). For example, a prototype function p may have the properties of: 1) p(0)=1 (e.g., 0 dB); and 2) p(l_{end})=0.5 (e.g., −6 dB), where l_{end} represents the right-most index for which p is defined. Continuing with this example, a gain transition function utilizing such a protype function p may be represented as:

$$t ( l ) = \{ \begin{matrix}{p ( l )}^{( e ( j ) - e ( j - 1 ) )} * {2}^{- e ( j - 1 )} , & l = 0 … {l}_{end} \\ {2}^{- e ( j )} , & l = {l}_{end} + 1 … L - 1\end{matrix}$$

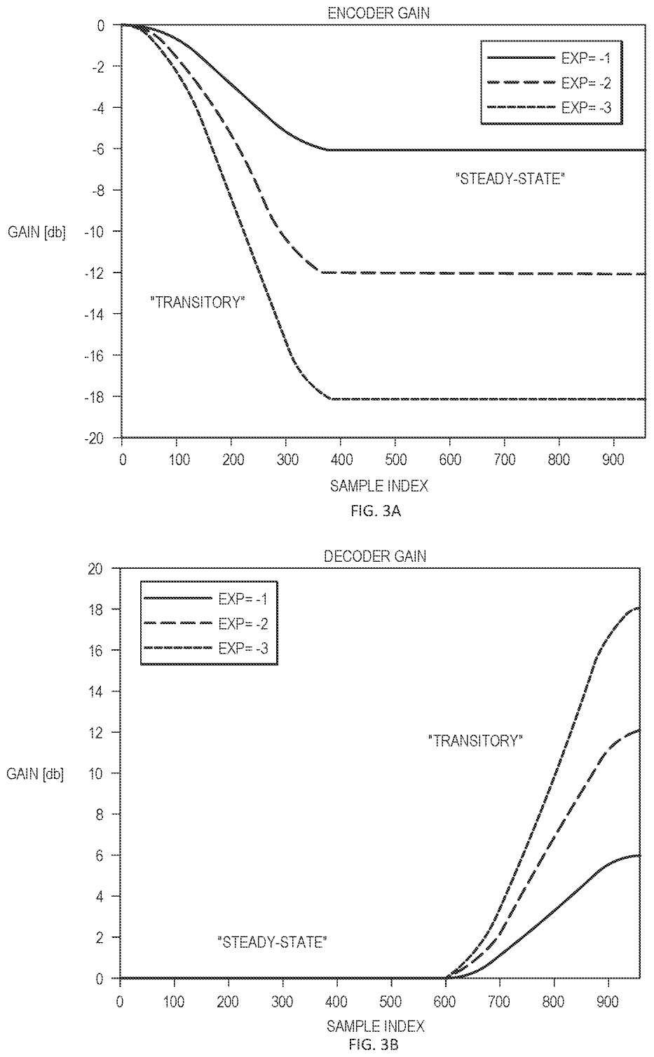

Examples of gain transition functions, each having a transitory portion having a transitory type of “fade,” are shown in FIG. 3A. In the examples shown in FIG. 3A, each gain transition function has a transitory portion that begins at sample 0, which may correspond to the beginning of the current frame, with a gain of 0 dB, where 0 dB is the gain parameter of the preceding frame (e.g., the j−1^{th} frame). In the example shown in FIG. 3A, the transitory portion of each gain transition function changes over the course of about 384 samples to the steady-state portion of the gain transition function. For each of the three gain transition function shown in FIG. 3A, the steady-state portion corresponds to a different gain parameter for the j^{th} frame, with an increase in gain of 6 dB, 12 dB, and 18 dB, respectively, relative to the gain of the preceding frame. In other words, as shown in FIG. 3A, for the three gain transition functions, exp=−[e(j)−e(j−1)]=−1, −2, and −3, respectively. It should be noted that, for each of the gain transition functions shown in FIG. 3A, the transitory portion is of the same length (e.g., about 384 samples). Note that the length of the steady-state portion may correspond to an offset related to the delay introduced by the codec, e.g., 12 milliseconds in the example shown in FIG. 3A. Correspondingly, the length of the transitory portion may be related to the reciprocal of the offset. In the example shown in FIG. 3A, the length of the transitory portion is the frame length (e.g., 20 milliseconds) minus the codec delay (e.g., 12 milliseconds). Note that the codec delay may be the overall coder algorithmic delay excluding the frame size delay.

Additionally, it should be noted that, gain transition functions having a transitory portion of a transitory type of “reverse fade” or “un-fade” may be represented as mirror images flipped across a horizontal line of the gain transition functions shown in FIG. 3A. By way of example, the horizontal line may be the x-axis.

Referring back to FIG. 2, decoder 212 can receive, as an input, an encoded bitstream and can reconstruct the HOA signals, e.g., for rendering. In some embodiments, a core decoder 216 receives the M downmixed channels for which gain was applied by encoder 202 and provides the M downmixed channels to an inverse gain control 220. Inverse gain control 220 obtains the gain parameters that were applied by encoder 202 from side information 210. For example, in some implementations, inverse gain control 220 may retrieve the gain parameter e(j) applied by encoder 202 from side information 210. Additionally, inverse gain control block 220 may retrieve, e.g., from memory, the gain parameter applied by the encoder to the preceding frame, e.g., e(j−1). Inverse gain control block 220 may then reverse the gain applied by encoder 202 using the obtained gain parameters. For example, in some implementations, inverse gain control 220 may construct an inverse gain transition function that transitions from the gain parameter of the preceding frame to the gain parameter of the current frame. In some implementations, the inverse gain transition function may be the gain transition function applied by encoder 202 mirrored across a center vertical line and vertically adjusted. By way of example, the vertical line may be the y-axis.

Turning to FIG. 3B, an example of an inverse gain transition function that would be applied by a decoder responsive to the gain transition function shown in FIG. 3A being applied by an encoder is shown in accordance with some implementations. As illustrated, the inverse gain transition function has a steady-state portion and a transitory portion. The durations of the steady-state portions and the transitory portions of the inverse gain transition function may correspond to, e.g., be the same as, the durations of the corresponding steady-state portions and transitory portions of the gain transition function, as illustrated in FIGS. 3A and 3B. As illustrated, each inverse gain transition function shown in FIG. 3B begins at 0 dB and transitions to the inverse gain to be applied to the current jth frame. That is, each inverse gain transition functions begins at 0 dB corresponding to the inverse gain applied to the preceding frame j−1. It should be noted that, where the gain applied by the encoder corresponds to an attenuation, indicated with a gain of less than 0 dB as shown in the gain transition function of FIG. 3A, the inverse gain applied by the decoder corresponds to an amplification with a gain of greater than 0 dB as shown in the gain transition function of FIG. 3B. Conversely, in instances where the gain applied by the encoder corresponds to an amplification, e.g., with a gain of greater than 0 dB, the inverse gain applied by the decoder corresponds to an attenuation, e.g., with a gain of less than 0 dB.

Referring back to FIG. 2, after the inverse gain has been applied, the M downmix channels with inverse gain applied are provided to a spatial decoding block 222. Spatial decoding block 222 may reconstruct the HOA signals using side information 210. For example, in instances in which spatial encoding block 204 utilizes SPAR techniques for spatial encoding, spatial decoding block 222 may utilize SPAR techniques to reconstruct one or more channels which were encoded using metadata included in side information 210. The reconstructed HOA output may then be rendered by a rendering/playback block 224. Rendering/playback block 224 may include, for example, various algorithms for rendering the reconstructed HOA output, e.g., as rendered audio data. For example, rendering the reconstructed HOA output may involve distributing the one or more signals of the HOA output across multiple speakers to achieve a particular perceptual impression. Optionally, rendering/playback block 224 may include one or more loudspeakers, headphones, etc. for presenting the rendered audio data.

In some implementations, a decoder may utilize various techniques to recover from dropped or lost frames, which may occur during, for example, cellular transmissions or in connection with other error-prone environments. In instances in which frames are not dropped, and the decoder has access to gain parameters utilized in connection with the preceding frame, the decoder may determine inverse gain transition functions based on gain parameters associated with the previous frame. However, in cases in which a frame is dropped, when processing the first recovered frame after the dropped frame (generally referred to herein as a “recovery frame”), the decoder does not have access to the gain parameters of the frame preceding the recovered frame, because the preceding frame, and the associated gain parameters, are missing. Accordingly, in some implementations, the decoder may reconstruct, for the dropped frame, a substitute frame using any suitable frame loss concealment techniques. The decoder may then utilize the gain parameters of the previously received frame for the substitute frame.

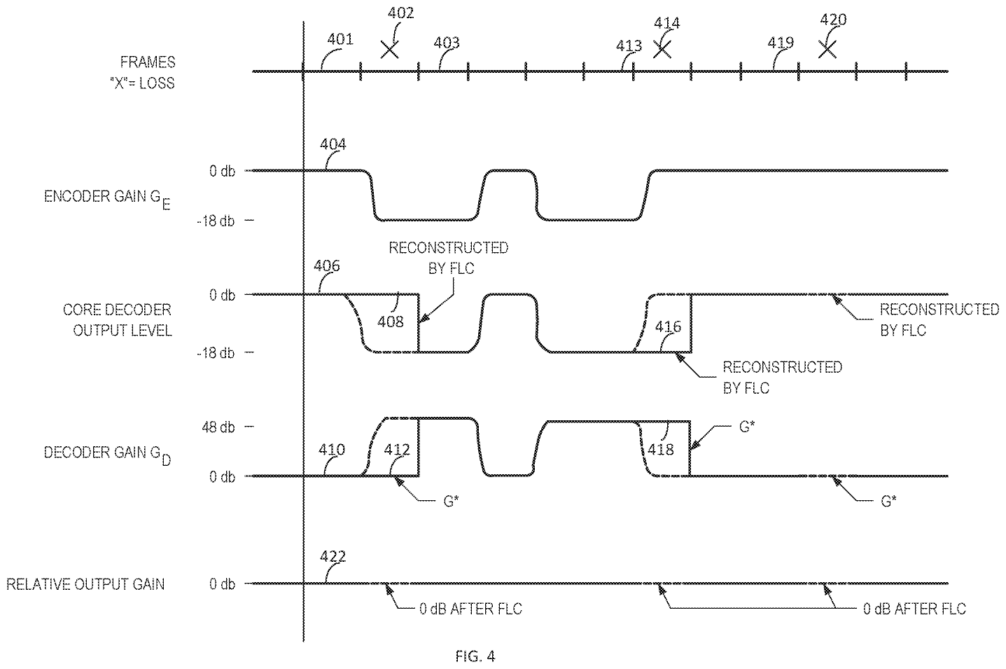

FIG. 4 shows an example of encoder gains and corresponding decoder gains for a series of frames in accordance with some implementations. As illustrated, a dropped frame 402 (depicted as an “X” in FIG. 4) is preceded by a received frame 401 and followed by a recovery frame 403. The encoder applies encoder gains G_{E}, as shown in curve 404. In particular, G_{E} is 0 dB for received frame 401, and −18 dB for dropped frame 402 and recovery frame 403. As illustrated by core decoder output level curve 406, dropped frame 402 is reconstructed using frame loss concealment techniques to generate a substitute frame. The substitute frame may have a coder decoder output level that corresponds to the decoder gain of the preceding frame as shown at 408, e.g., the gain of received frame 401, or 0 dB. Correspondingly, as illustrated by decoder gain curve 410, the substitute frame has a decoder gain G* that is equivalent to the decoder gain of the preceding frame, e.g., received frame 401, as shown at 412.

A similar process may occur for a dropped frame 414. In this case, the encoder gain G_{E} for dropped frame 414 is 0 dB, whereas the encoder gain for the preceding received frame 413 is −18 dB. In other words, dropped frame 414 occurs during a gain transition from −18 dB to 0 dB. Accordingly, using frame loss concealment techniques, the core decoder output level reconstructs a gain of −18 dB for a substitute frame. The reconstructed gain for the substitute frame corresponds to the encoder gain of −18 dB for preceding received frame 413 as shown at 416. Correspondingly, the decoder gain for the substitute frame may be set as that of preceding received frame 413, or 18 dB, as shown at 418. Note that, for a dropped frame 420 in which the encoder gain is the same for dropped frame 420 as for preceding frame 419, setting a decoder gain for a substitute frame corresponding to dropped frame 420 results in no decoder gain discontinuity, because there is no change in gain between preceding frame 419 and dropped frame 420.

Additionally, it should be noted that, as shown in relative output gain curve 422, utilizing a technique of setting a decoder gain for a substitute frame as equal to the decoder gain for the previously received frame may result in an overall relative output gain of 0 dB, indicating no fluctuations between frames, which may be desirable in reducing perceptual discontinuities due to changes in output gains across frames.

In some implementations, a decoder may perform a smoothing technique to transition from the gain parameters of the previously received frame to those of the recovery frame, e.g., to smooth across the substitute frame for which no gain parameters were received.

In some implementations, the smoothing technique may involve the decoder blending the substitute frame and the recovery frame in a manner that gives increased weight to the substitute frame during an initial portion of blending samples, and increased weight to the recovery frame during a subsequent portion of the blending samples.

As another example, in some implementations, the smoothing technique may involve adjusting the decoder state memory prior to decoding the recovery frame to account for the gain of the lost frame. As a more particular example, in an instance in which it is determined that the gain of the recovered frame is too high, the decoder state memory may be adjusted downward such that the recovery frame is decoded with a suitably lowered decoder state memory. In other words, the decoder state memory may be scaled downward responsive to a determination that the reconstructed decoder gain G* for the preceding frame is less than the decoder gain G of the recovery frame. Conversely, in an instance in which it is determined that the gain of the recovered frame is too low, the decoder state memory may be adjusted upward such that the recovery frame is decoded with a suitably increased decoder state memory. In other words, the decoder state memory may be scaled upward responsive to a determination that the reconstructed decoder gain G* for the preceding frame is greater than the decoder gain G of the recovery frame. Accordingly, the decoder gain G for the recovery frame may be adjusted based on the reconstructed decoder gain G*. Note that, because the reconstructed decoder gain G* may be determined based on the gain for the frame that preceded the dropped frame, e.g., frame 401 of FIG. 4, the decoder gain G for the recovery frame may be adjusted based at least in part on the decoder gain for the frame that preceded the dropped frame.

As yet another example, in some implementations, the smoothing technique may involve applying a smoothing function between the previously received frame and the recovery frame. Such a smoothing function may correspond to a smoothing function that is implemented and utilized by the decoder, thereby allowing smoothing to be performed without additional overhead. Alternatively, in some implementations, the smoothing function may be a dedicated smoothing function utilized in the case of dropped frame. In such implementations, the smoothing function may depend on a duration of packet loss, which may be indicated in seconds, blocks, or numbers of frames, which may be advantageous in cases in which multiple sequential frames are dropped.

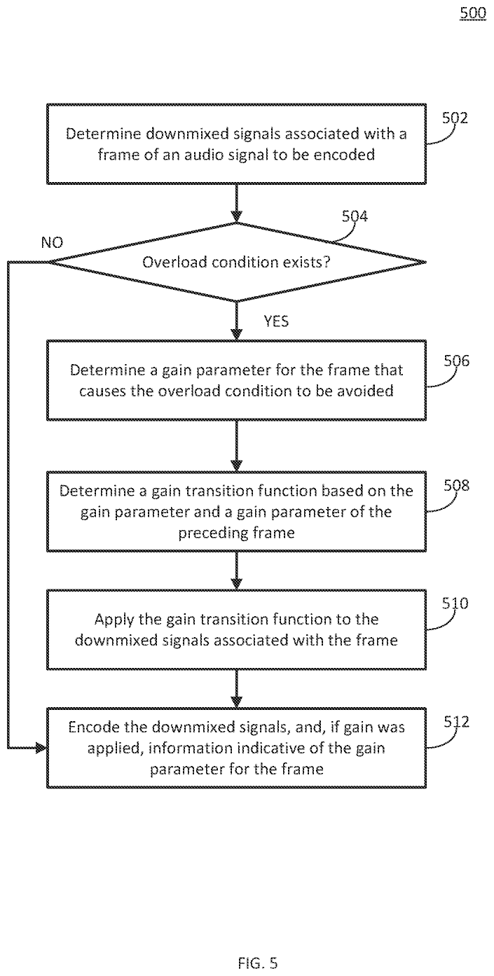

FIG. 5 shows an example of a process 500 for determining gain parameters and applying gain to downmixed signals according to the determined gain parameters in accordance with some implementations. In some implementations, blocks of process 500 may be performed by an encoder device. In some implementations, blocks of process 500 may be performed in an order other than what is shown in FIG. 5. In some implementations, two or more blocks of process 500 may be performed substantially in parallel. In some implementations, one or more blocks of process 500 may be omitted.

At 502, process 500 may determine downmixed signals associated with a frame of an audio signal to be encoded. For example, in some implementations, process 500 may use any suitable spatial encoding technique to determine a set of downmixed channels. Examples of spatial encoding techniques include SPAR, a linear predictive technique, or the like. The set of downmixed channels may include anywhere from one to N channels, where N is the number of input channels, e.g., in the case of FOA signals, N is 4. The downmixed signals may include audio signals corresponding to the downmixed channels for a particular frame of the audio signal. It should be noted that, in some implementations, rather than determining downmixed signals, process 500 may determine “transport signals.” Such transport signals may refer to signals to be encoded, which may not necessarily be downmixed.

At 504, process 500 may determine whether an overload condition exists for a codec, such as for the Enhanced Voice Services (EVS) codec, and/or for any other suitable codec. For example, process 500 may determine that an overload condition exists responsive to determining that signals for at least one downmix channel exceed a predetermined range, e.g., [−1, 1), and/or any other suitable range.

If, at 504, it is determined that no overload condition exists (“no” at 504), process 500 can proceed to 512 and can encode the downmixed signals. For example, in some implementations, process 500 can generate a bitstream that encodes the downmixed signals in connection with side information, such as metadata, that can be utilized by a decoder to upmix the downmixed signals, e.g., to reconstruct a FOA or HOA output.

Conversely, if, at 504, it is determined that an overload condition exists (“yes” at 504), process 500 can proceed to 506 and can determine a gain parameter for the frame that causes the overload condition to be avoided. For example, in some implementations, process 500 may determine a gain parameter by determining a minimum positive integer such that, when scaling the downmixed signals of the downmixed channel by a gain factor determined based on the gain parameter, the downmixed signals are within the predetermined range, e.g., within [−1, 1). For example, as described above in connection with FIG. 2, the gain parameter may be represented as a positive integer (including 0) e(j) for the current frame (j), where applying a gain factor 2^{-e(j)} to the downmixed signals causes the downmixed signals to be within the predetermined range.

At 508, process 500 can determine a gain transition function based on the gain parameter for the current frame (e.g., frame j) determined at block 506 and a gain parameter of the preceding frame (e.g., frame j−1). For example, as described above in connection with FIG. 2, the gain transition function may have a transitory portion and a steady-state portion, where the steady-state portion corresponds to the gain factor for the current frame, and the transitory portion corresponds to a sequence of intermediate gain factors for a subset of samples of the current frame that transition from the gain factor at the end of the preceding frame to the gain factor for the stead-state portion of the current frame.

In instances in which the gain parameter of the preceding frame corresponds to less attenuation than the gain parameter of the current frame, the transitory portion may be referred to as having a transitory type of “fade.” Conversely, in instances in which the gain parameter of the preceding frame corresponds to more attenuation than the gain parameter of the current frame, the transitory portion may be referred to as having a transitory type of “reverse fade” or “un-fade.” In instances in which the gain parameter of the preceding frame is the same as the gain parameter of the current frame, the transitory portion may be referred to as having a transitory type of “hold,”. In instances in which the transitory portion has a transitory type of “hold,” the value of the gain transition function during the transitory portion may be the same as the value of the gain transition function during the steady-state portion. In some implementations, a transitory portion of the gain transition function may be determined by scaling a prototype function based on the gain parameters of the preceding and/or current frames. As described above in connection with FIG. 2, the duration of the transitory portion of the gain transition function may correspond to a delay duration utilized by a codec.

At 510, process 500 may apply the gain transition function to the downmixed signals associated with the frame. For example, in some implementations, process 500 may scale the samples of the downmixed signals by gain factors indicated by the gain transition function. As a more particular example, in some implementations, a first sample of the current frame may be scaled by a gain factor corresponding to the gain parameter of the preceding frame, a last sample of the current frame may be scaled by a gain factor corresponding to the gain parameter of the current frame, and intervening samples may be scaled by gain factors corresponding to the gain parameters of the transitory or steady-state portions of the gain transition function. Note that, in instances in which process 500 is applied to transport signal, e.g., as described above in connection with block 502, process 500 may apply the gain transition function to the transport signals.

It should be noted that, in some implementations, the gain transition function may be applied to only the downmixed signals of the downmix channels for which the overload condition was detected at block 504. For example, in an instance in which an overload condition was detected for the Y′ channel and the X′ channel, separate gain transition functions may be determined for each of the Y′ channel and the X′ channel, and applied to the signals of the Y′ channel and the X′ channel. Continuing with this example, the gain transition function may not be applied to the W′ and Z′ channels. In such instances, indications of the channels to which gain transition functions are applied, as well as the corresponding gain parameters for each channel may be encoded, e.g., at block 512. Alternatively, in some implementations, in instances in which an overload condition exists for only one downmix channel, the corresponding gain transition function may be applied to all downmix channels. In such instances, because the gain transition function is applied to all channels, indications of channels to which gain has been applied need not be transmitted, which may lead to increased bit rate efficiency.

At 512, process 500 can encode the downmixed signals and, if gain was applied, information indicative of the gain parameter(s) for the frame. In instances in which gain was applied, the encoded downmixed signals may be the downmixed signals after application of the gain transition function at block 510. The downmixed signals and any information indicative of gain parameters may be encoded by a codec, such as the EVS codec, or the like, in connection with any side information, such as metadata, that may be used by a decoder to reconstruct or upmix the downmixed signals. Note that, in instances in which process 500 utilizes transport signals, e.g., as described above in connection with block 502, process 500 may encode the transport signals.

It should be noted that, in some implementations, process 500 can encode the gain parameters in a set of bits. In some implementations, an additional bit may be used as an exception flag, e.g., to indicate the transition function. In some implementations, the gain transition function may indicate a prototype function associated with the transitory portion of the gain transition function. In some implementations, the gain transition function may indicate a hard transition, e.g., a step function, that occurs in instances in which a sudden and relatively large level change occurs between frames, and therefore, in which a smooth transition cannot be implemented by gain control. By setting such an exception using the exception flag, a decoder may implement the hard transition. A gain parameter may be encoded using x bits, where x depends on a number of quantized values of the gain parameter for a current frame, e.g., a number of quantized values for e(j). For example, x may be determined by ceil(log₂(number of quantized values of the gain parameter). In one example, in an instance in which e(j) may take values of 0, 1, 2, and 3, x is 2 bits.

In instances in which adaptive gain control is enabled per channel such that unique gain transition functions are applied to each downmix channel associated with signals that trigger an overload condition, x bits may be utilized for each channel for which gain control is enabled, with an additional one bit indicator per channel indicating that gain parameters have been encoded. In such an instance, a total number of bits used transmit gain control information is N_{dmx}+(x+1)*N, where N_{dmx} represents the number of downmix channels (and where a single bit is utilized to indicate, for each of the N_{dmx} channels, whether gain control is enabled), and where N represents the number of channels for which gain control has been enabled. It should be noted that, in instances in which gain control is not enabled for a particular frame, N_{dmx} bits may be used to indicate that gain control is not enabled, e.g., 1 bit for each of the N_{dmx} channels. Note that, in instances in which the number of downmix channels is 1, e.g., only the W channel is waveform encoded, the total number of bits used to transmit gain control information is represented by (x+1)*N. For example, given one downmix channel, if gain control is not enabled for the one downmix channel (e.g., N=0), the number of bits used is 0. Continuing with this example, if gain control is enabled, (e.g., N=1), the number of bits used is x+1. Note that, in the term “x+1,”, the 1 represents a 1-bit exception flag (e.g., that may be used to indicate that a hard transition, such as a step function, is to be implemented to transition between successive frames, as described below in more detail).

In instances in which a single gain transition function associated with a downmix channel that triggers an overload condition is applied to all downmix channels, fewer bits may be used to transmit the gain control information. For example, a single gain parameter for the current frame is transmitted using x bits in connection with an exception flag indicting, e.g., the transition function. As a more particular example, in such implementations, the total number of bits used for a frame to transmit gain control information is represented by x+1.

In some implementations, process 500 may allocate the bits used to transmit the gain control information for the frame from bits typically allocated to transmitting side information, such as metadata utilized to reconstruct the HOA signal, and/or from bits typically allocated to encode the downmixed channels. Example techniques for allocating gain control bits are shown in and described below in connection with FIGS. 7 and 8.

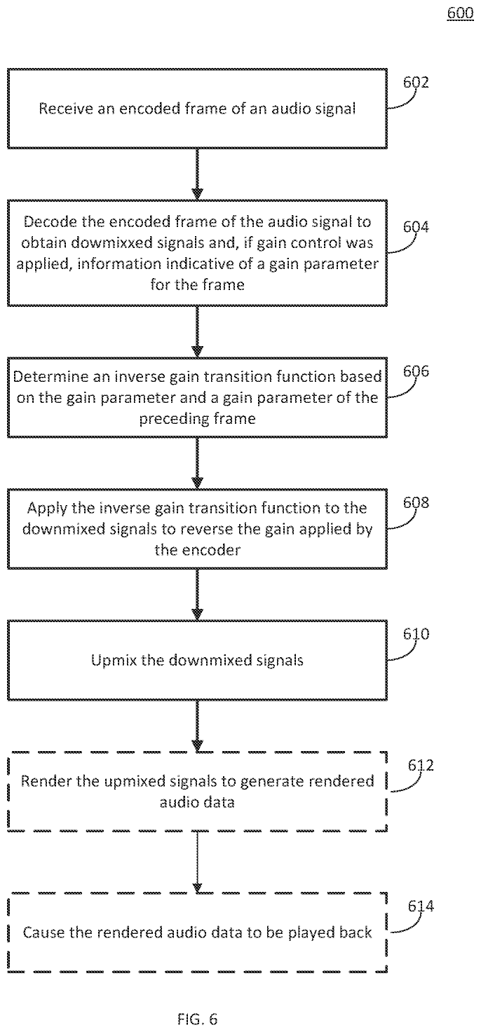

FIG. 6 shows an example of a process 600 for obtaining gain parameters utilized by an encoder and applying an inverse gain transition function based on the obtained gain parameters in accordance with some implementations. In some implementations, blocks of process 600 may be performed by a decoder device. In some implementations, blocks of process 600 may be performed in an order other than what is shown in FIG. 6. In some implementations, two or more blocks of process 600 may be performed substantially in parallel. In some implementations, one or more blocks of process 600 may be omitted.

Process 600 may begin at 602 by receiving an encoded frame of an audio signal. The received frame (e.g., the current frame) is generally referred to herein as the j^{th} frame. The received frame may be immediately after a previously received frame, or may be a frame that is not immediately after a previously received frame.

At 604, process 600 can decode the encoded frame of the audio signal to obtain downmixed signals, and, if gain control was applied by the encoder, information indicative of at least one gain parameter associated with the frame. In some implementations, process 600 may determine whether gain control was applied by the encoder based on an exception flag, e.g., a one-bit exception flag, that indicates whether a hard transition, e.g., a step function transition, is to be implemented. In other words, in instances in which the exception flag is not set, the decoder may determine that a smooth transition is to be performed between successive frames. In instances in which the encoder applies gain control on a per-channel basis, process 600 may additionally identify which downmix channels gain control was applied to.

At 606, process 600 may determine an inverse gain transition function based on the gain parameter of the current frame (generally referred to herein as e(j)) and a gain parameter of the preceding frame (e.g., generally referred to herein as e(j−1)). In some implementations, process 600 may retrieve the gain parameter of the preceding frame from memory, e.g., from decoder state memory. In instances in which gain control was not applied to the previous frame, process 600 may set e(j−1) to 0.

In some implementations, process 600 may determine the inverse gain transition function to be the inverse of the gain transition function applied at the encoder. For example, the inverse gain transition function may correspond to the gain transition function mirrored across a horizontal line and adjusted. Mirroring and adjustment may be along the x-axis. An example of such an inverse gain transition function is shown in and described above in connection with FIG. 3B. In some implementations, the inverse gain transition function may have a steady-state portion that corresponds to the gain applied to the preceding frame (where the gain is determined based on the gain parameter of the preceding frame, or, set at 0 in instances in which gain control was not applied to the preceding frame). The inverse gain transition function may then have a transitory portion that is the inverse of the transitory portion of the gain transition function applied at the encoder. For example, in an instance in which the gain applied to the current frame corresponds to more attenuation relative to the preceding frame, the inverse gain transition function may have a transitory portion that transitions from less amplification to more amplification. Conversely, in an instance in which the gain applied to the current frame corresponds to less attenuation relative to the preceding frame, the inverse gain transition function may have a transitory portion that transitions from more amplification to less amplification. A duration of the transitory portion may relate to the delay introduced by the codec, where the duration of the transitory portion is the frame length (e.g., 20 milliseconds) minus the codec delay (e.g., 12 milliseconds). Note that, in instances in which the delay introduced by the codec is longer than a frame length, the inverse gain transition may be applied with a delay of one frame. In some instances, the delay may be obtained by process 600 (e.g., by the decoder) from the gain control bits. It should be noted that the inverse gain transition function may also serve to attenuate signals that were amplified by the gain control of the encoder.

At 608, process 600 may apply the inverse gain transition function to the downmixed signals to reverse the gain applied by the encoder. For example, application of the inverse gain transition function may cause downmixed signals that were attenuated by the encoder to be amplified to reverse the attenuation. As another example, application of the inverse gain transition function may cause downmixed signals that were amplified by the encoder to be attenuated to reverse the amplification.

At 610, process 600 can upmix the downmixed signals. Upmixing may be performed by a spatial encoder. In some examples, the spatial encoder may utilize SPAR techniques. The upmixed signals may correspond to a reconstructed FOA or HOA audio signal. In some implementations, process 600 may upmix the signals using side information, e.g., metadata, encoded in the bitstream, where the side information may be utilized to reconstruct parametrically-encoded signals.

In some implementations, at 612, process 600 may render the upmixed signals to generate rendered audio data. In some implementations, process 600 may utilize any suitable rendering algorithms to render a FOA or HOA audio signal, e.g., to rendered scene-based audio data. In some implementations, rendered audio data may be stored in any suitable format, e.g., for future presentation or playback. It should be noted that, in some implementations, block 612 may be omitted.

In some implementations, at 614, process 600 may cause the rendered audio data to be played back. For example, in some implementations, the rendered audio data may be presented via one or more of loudspeakers and/or headphones. In some implementations, multiple loudspeakers may be utilized, and the multiple loudspeakers may be positioned in any suitable positions or orientations relative to each other in three dimensions. It should be noted that, in some implementations, process 614 may be omitted.

As described above in connection with FIG. 5, gain control information, e.g., information indicative of gain parameters, may be encoded using a set of gain control bits. In some implementations, different gain parameters and gain transition functions may be determined for each downmix channel for which an overload condition is detected. In such implementations, gain control bits are needed to indicate whether or not gain control is being applied to each of the downmix channels, and gain parameters are encoded for each of the downmix channels for which gain control is applied, as described above in connection with FIG. 5. Alternatively, in some implementations, a single gain transition function that is determined based on one downmix channel for which an overload condition exists may be applied to all of the downmix channels. In such implementations, fewer gain control bits are needed, because a separate bit flag is not required to signify whether or not gain control has been applied for each downmix channel, thus leading to a more bitrate efficient encoding.

A more bitrate efficient encoding by applying the same gain transition function to all downmix channels, including for downmix channels for which no overload condition exists, may result in degradation of perceptual quality, by, for example, attenuating signals for which no overload of the codec exists. By contrast, utilizing a more targeted gain control, in which gain control is applied in a targeted manner to each downmix channel, may require more bits to transmit gain control information. However, utilizing additional bits to transmit targeted, e.g., channel-specific, gain control information may require re-allocation of bits typically used to waveform encode the downmix channels, which may in some cases reduce perceptual quality. Accordingly, there may be a situation-dependent tradeoff between applying the same gain transition function to all downmix channels and applying channel-specific gain control. Regardless of whether gain control is applied across all downmix channels or on a targeted per-channel basis, bits associated with gain control information may be allocated from bits that would typically be used for waveform encoding of the downmix channel and/or from bits that would typically be used for encoding side information, such as metadata, used to reconstruct an FOA or HOA signal from the downmix channels, thereby reducing the number of available bits for encoding either the downmix channels or the side information.

Described below are more detailed techniques for bit distribution for encoding gain control information. To provide background, FIG. 7A describes a FOA codec for encoding and decoding audio signals using SPAR techniques utilizing the adaptive gain control techniques described above in connection with FIGS. 2-6. It should be noted that although FIG. 7A describes utilizing SPAR techniques for spatial encoding, the techniques described in connection with FIGS. 7A and 8 may be utilized in connection with any suitable spatial encoding techniques. FIG. 8 shows a flowchart of an example process 800 for allocating bits used to encode gain control information in accordance with some embodiments.

FIG. 7A is a block diagram of an FOA codec 700 for encoding and decoding FOA in SPAR format, according to some implementations. FOA codec 700 includes SPAR encoder 701, Core encoder 705, Adaptive Gain Control (AGC) encoder 713, SPAR decoder 706, Core decoder 707 and AGC decoder 714. In some implementations, SPAR encoder 701 converts a FOA input signal into a set of downmix channels and parameters used to regenerate the input signal at SPAR decoder 706. The downmix signals can vary from 1 to 4 channels and the parameters may include prediction coefficients (PR), cross-prediction coefficients (C), and decorrelation coefficients (P). More detailed techniques for utilizing SPAR to reconstruct an audio signal from a downmix version of the audio signal using the PR, C and P parameters, are described in further detail below.

Note that the example implementation shown in FIG. 7A illustrates a nominal 2-channel downmix, where the W (passive prediction) or W′ (active prediction) channel is sent with a single predicted channel Y′ to SPAR decoder 706. In some implementations, W′ can be an active channel. An active W′ downmix channel may be constructed by mixing of X, Y, and Z channels into the W channel based on mixing gains. In one example, an active prediction of the W channel may be determined using:

W′=W+f*pr_{y}*Y+f*pr_{z}*Z+f*pr_{z}*X

In the above, f represents a function of normalized input covariance that allows mixing of some of the X, Y, Z channels into the W channel and pr_{Y}, pr_{X}, pr_{Z} represent the prediction coefficients. In some implementations, f can also be a constant, e.g., 0.50. In passive W, f=0, and accordingly, there is no mixing of X, Y, Z channels into the W channel.

The cross-prediction coefficients (C) allow some portion of the parametric channels to be reconstructed from the residual channels, in the cases where at least one channel is sent as a residual and at least one is sent parametrically, i.e., for 2 and 3 channel downmixes. For two channel downmixes (as described in further detail below), the C coefficients allow some of the X and Z channels to be reconstructed from Y′, and the remaining signal component that cannot be reconstructed from PR and C parameters are reconstructed by decorrelated versions of the W channel, as described in further detail below. In the 3 channel downmix case, Y and X are used to reconstruct Z alone.

In some implementations, SPAR encoder 701 includes passive/active predictor unit 702, remix unit 703 and extraction/downmix selection unit 704. In some implementations, passive/active predictor may receive FOA channels in a 4-channel B-format (W, Y, Z, X) and may compute downmix channels (representation of W (or W′), Y′, Z′, X′).

In some implementations, extraction/downmix selection unit 704 extracts SPAR FOA metadata from a metadata payload section of the bitstream (e.g., an Immersive Voice and Services (IVAS) bitstream), as described in more detail below. Passive/active predictor unit 702 and remix unit 703 use the SPAR FOA metadata to generate remixed FOA channels (W or W′ and A′), which are input into core encoder 705 to be encoded into a core encoding bitstream (e.g., an EVS bitstream), which is encapsulated in the IVAS bitstream sent to SPAR decoder 706. Note in this example the Ambisonic B-format channels are arranged in the AmbiX convention. However, other conventions, such as the Furse-Malham (FuMa) convention (W, X, Y, Z) can be used as well.

Referring to SPAR decoder 706, the core encoding bitstream (e.g., an EVS bitstream) is decoded by core decoder 707 resulting in N_{dmx} (e.g., N_{dmx}=2) downmix channels. In some implementations, SPAR decoder 706 performs a reverse of the operations performed by SPAR encoder 701. For example, in the example of FIG. 7A, the remixed FOA channels (representation of W′, A′, B′, C′) are recovered from the 2 downmix channels using the SPAR FOA spatial metadata. The remixed SPAR FOA channels are input into inverse mixer 711 to recover the SPAR FOA downmix channels (representation of W′, Y′, Z′, X′). The predicted SPAR FOA channels are then input into inverse predictor 712 to recover the original unmixed SPAR FOA channels (W, Y, Z, X).

Note that in this two-channel example, decorrelator blocks 709A (dec₁) and 709B (dec₂) are used to generate decorrelated versions of the W′ channel using a time domain or frequency domain decorrelator. The downmix channels and decorrelated channels are used in combination with the SPAR FOA metadata to parametrically reconstruct the X and Z channels. C block 708 represents the multiplication of the residual channel by the 2×1 C coefficient matrix, creating two cross-prediction signals that are summed into the parametrically reconstructed channels, as shown in FIG. 7A. P₁ block 710A and P₂ block 710B represent multiplication of the decorrelator outputs by columns of the 2×2 P coefficient matrix, creating four outputs that are summed into the parametrically reconstructed channels, as shown in FIG. 7A.

In some implementations, depending on the number of downmix channels, one of the FOA inputs is sent to SPAR decoder 706 intact (the W channel), and one to three of the other channels (Y, Z, and/or X) are either sent as residuals or completely parametrically to SPAR decoder 706. The PR coefficients, which remain the same regardless of the number of downmix channels N_{dmx}, are used to minimize predictable energy in the residual downmix channels. The C coefficients are used to further assist in regenerating fully parametrized channels from the residuals. As such, the C coefficients are not required in the one and four channel downmix cases, where there are no residual channels or parameterized channels to predict from. The P coefficients are used to fill in the remaining energy not accounted for by the PR and C coefficients. The number of P coefficients is dependent on the number of downmix channels N in a frequency band. In some implementations, SPAR PR coefficients (passive W only) are determined, using the following four steps.

Step 1: Side signals, e.g., Y, Z, X, may be predicted from the main W signal, which may represent the omnidirectional signal. In some implementations, the side signals are predicted based on the predicted parameters associated with the corresponding predicted channels. In one example, the side signals Y, Z, and X may be determined using:

$$[ \begin{matrix}W \\ {Y}^{′} \\ {Z}^{′} \\ {X}^{′}\end{matrix} ] = [ \begin{matrix}1 & 0 & 0 & 0 \\ - {pr}_{y} & 1 & 0 & 0 \\ - {pr}_{z} & 0 & 1 & 0 \\ - {pr}_{x} & 0 & 0 & 1\end{matrix} ] [ \begin{matrix}W \\ Y \\ Z \\ X\end{matrix} ]$$

In the above, prediction parameters for each channel may be determined based on covariance matrices. In one example:

$${pr}_{y} = \frac{{R}_{YW}}{max ( {R}_{WW} , ε )} \frac{1}{max ( 1 , \sqrt{{\vert {R}_{yy} \vert}^{2} + {\vert {ZZ}_{zz} \vert}^{2} + {\vert {R}_{XX} \vert}^{2}} )}$$

In the above, R_{AB} represents the elements of the input covariance matrix of signals A and B. In some implementations, covariance matrices may be determined per frequency band. It should be noted that prediction parameters pr_{z} and prₓ may be determined for the Z′ and X′ residual channels, respectively, in a similar manner. It should be noted that, as used herein, the vector PR represents the vector of the prediction coefficients. For example, the vector PR may be determined as [pr_{y}, pr_{z}, prₓ]^{T}.

Step 2: the W channel and the predicted Y′, Z′, and X′ signals may be remixed. As used herein, remixing may refer to reordering or re-combining the signals based on a criteria. For example, in some implementations, the W channel and the predicted Y′, Z′, and X′ signals may be remixed from most to least acoustically relevant. As a more particular example, in some implementations, the signals may be remixed by re-ordering the input signals to W, Y′, X′ and Z′, because audio cues from the left-right direction, e.g., Y′ signals, may be more acoustically relevant than audio cues from the front-back direction, e.g., X′ signals, and audio cues from the front-back direction may in turn be more acoustically relevant than audio cues from the up-down direction, e.g., Z′ signals. In general, the remixed signals may be determined using:

$$[ \begin{matrix}W \\ {A}^{′} \\ {B}^{′} \\ {C}^{′}\end{matrix} ] = [ remix ] [ \begin{matrix}{W}^{′} \\ {Y}^{′} \\ {Z}^{′} \\ {X}^{′}\end{matrix} ]$$

In the above, [remix] represents a matrix that indicates criteria for re-ordering the signals.

Step 3: the covariance of the 4 channels post prediction and remixing of the downmix channels may be determined. For example, a covariance matrix Rₚᵣ of the 4 channels post-prediction and after remixing may be determined by:

Rₚᵣ=[remix]PR.R.PR^{H}[remix]

Using the above, the covariance matrix Rₚᵣ may have the format:

$${R}_{pr} = ( \begin{matrix}{R}_{WW} & {R}_{Wd} & {R}_{Wu} \\ {R}_{dW} & {R}_{dd} & {R}_{du} \\ {R}_{uW} & {R}_{ud} & {R}_{uu}\end{matrix} )$$

In the above, d represents the residual channels (e.g., if the number of downmixed channels is represented by N_{dmx}, the residual channels are the second channel to the N_{dmx}^{th} channel), and u represents the parametric channels that are to be fully reconstructed by the decoder (e.g., the N_{dmx}+1^{th} channel to the fourth channel). Given a naming convention of W, A, B, and C channels, where A, B, and C correspond to remixed X, Y, and/or Z channels, the following table illustrates the d and u channels for varying values of N_{dmx}.

| N_{dmx} | d | u |
|---|---|---|
| 1 | — | A′, B′, C′ |
| 2 | A′ | B′, C′ |
| 3 | A′, B′ | C′ |
| 4 | A′, B′, C′ | — |

In some implementations, utilizing the R_{dd}, R_{ud}, and Rᵤᵤ elements of the Rₚᵣ covariance matrix (described above), the FOA codec may determine whether a portion of the fully parametric channels may be cross-predicted from the residual channels transmitted to the decoder. For example, in some implementation, cross-prediction coefficients C may be determined based on the R_{dd}, R_{ud}, and Rᵤᵤ elements of the covariance matrix. In one example, the cross-prediction coefficients C may be determined by:

C=R_{ud}(R_{dd}+l max(ε,tr(R_{dd})*0.005))⁻¹

It should be noted that C may be of shape (1×2) for a 3-channel downmix, and of shape (2×1) for a 2-channel downmix.

Step 4: The remaining energy in parameterized channels that will be reconstructed by decorrelators 709A and 709B may be determined. In some embodiments, the remaining energy may be represented by a matrix P. Because P may be a covariance matrix, and therefore, Hermetian symmetric, in some implementations, only elements from the upper triangle or the lower triangle of matrix P are sent to the decoder. The diagonal elements of matrix P may be real, while off-diagonal elements may be complex. In some implementations, the remaining energy, represented by the matrix P may be determined based on the residual energy in the upmix channels, Resᵤᵤ. In one example, P may be determined by:

$$P = \sqrt{\frac{{Res}_{uu}}{max ( ε , {R}_{WW} , re ( \vert {Res}_{uu} \vert ) )}}$$

In another example, only diagonal elements may be used to calculate P parameters, wherein number of P parameters to be sent to decoder per frequency band is equal to number of channels that are to be parametrically reconstructed at the decoder. Here, P may be determined by:

$${NRes}_{uu} = \frac{{Res}_{uu}}{max ( ε , {R}_{ww} , scale * tr ( \vert {Res}_{uu} \vert} , where P = diag ( \sqrt{max ( 0 , real ( diag ( {NRes}_{uu} ) )} ) )$$

In the above, scale represents a normalization scaling factor. In some implementations, scale may be a broadband value. In one example, scale=0.01. Alternatively, in some implementations, scale may be frequency dependent. In some such implementations, scale may take different values in different frequency bands. In one example, the spectrum may be divided into 12 frequency bands, and scale may be determined by, e.g., linspace(0.5, 0.01, 12).

In some implementations, the residual energy in the upmix channels, Resᵤᵤ, may be determined based on the actual energy post-prediction (e.g., Rᵤᵤ) and a regenerated cross-prediction energy Regᵤᵤ. In one example, the residual energy in the upmix channels may be the difference between the actual energy post-prediction and the regenerated cross-prediction energy Regᵤᵤ. In one example, Resᵤᵤ=Rᵤᵤ−Regᵤᵤ. In some implementations, the regenerated cross prediction energy Regᵤᵤ may be determined based on the cross-prediction coefficients and the prediction covariance matrix. For example, in some implementations, Regᵤᵤ may be determined by:

Resᵤᵤ=Rᵤᵤ−Regᵤᵤ

Referring back to FIG. 7A, in some implementations, signals associated with the downmixed channels, e.g., W′, Y′, X′, and/or Z′, are provided to AGC encoder 713. AGC encoder 713 may then determine gain parameters responsive to a determination that an overload condition exists for at least one of the downmixed channels, e.g., using the techniques described above in connection with FIGS. 2 and 5. The gain parameters and information associated with the PR, C, and/or P matrices may be encoded as side information, such as metadata.

FIG. 7B is a block diagram of IVAS codec 750 for encoding and decoding IVAS bitstreams, according to an embodiment. IVAS codec 750 includes an encoder and far end decoder. The IVAS encoder includes spatial analysis and downmix unit 752, quantization and entropy coding unit 753, AGC gain control unit 762, core encoding unit 756 and mode/bitrate control unit 757. The IVAS decoder includes quantization and entropy decoding unit 754, core decoding unit 758, Inverse gain control unit 763, spatial synthesis/rendering unit 759 and decorrelator unit 761.

Spatial analysis and downmix unit 752 receives N-channel input audio signal 751 representing an audio scene. Input audio signal 751 includes but is not limited to: mono signals, stereo signals, binaural signals, spatial audio signals, e.g., multi-channel spatial audio objects, FOA, higher order Ambisonics (HOA) and any other audio data. The N-channel input audio signal 751 is downmixed to a specified number of downmix channels (N_{dmx}) by spatial analysis and downmix unit 752. In this example, N_{dmx} is <=N. Spatial analysis and downmix unit 752 also generates side information (e.g., spatial metadata) that can be used by a far end IVAS decoder to synthesize the N-channel input audio signal 751 from the N_{dmx} downmix channels, spatial metadata and decorrelation signals generated at the decoder. In some embodiments, spatial analysis and downmix unit 752 implements complex advanced coupling (CACPL) for analyzing/downmixing stereo/FOA audio signals and/or spatial reconstructor (SPAR) for analyzing/downmixing FOA audio signals. In other embodiments, spatial analysis and downmix unit 752 implements other formats.

The N_{dmx} downmix channels may include a set of signals which are bound by [−max, max] for a given frame. Because a core encoder 756 can encode signals within a range of [−1, 1), samples of the signals associated with the downmix channels that exceed the range of core encoder 756 may cause overload. To bring the downmix channels within desired range, the N_{dmx} channels are fed to the gain control unit 762 which dynamically adjusts the gain of the frame such that the downmix channels are within the range of the core coder. The gain adjustment information (AGC metadata) is sent to a quantization and coding unit 753 that codes the AGC metadata.

The gain adjusted N_{dmx} channels are coded by one or more instances of core codecs included in core encoding unit 756. The side information, e.g., spatial metadata (MD), along with AGC metadata is quantized and coded by quantization and entropy coding unit 753. The coded bits are then packed together into IVAS bitstream(s) and sent to the IVAS decoder. In an embodiment, the underlying core codec can be any suitable mono, stereo or multi-channel codec that can be used to generate encoded bitstreams.

In some embodiments, the core codec is an EVS codec. EVS encoding unit 756 complies with 3GPP TS 26.445 and provides a wide range of functionalities, such as enhanced quality and coding efficiency for narrowband (EVS-NB) and wideband (EVS-WB) speech services, enhanced quality using super-wideband (EVS-SWB) speech, enhanced quality for mixed content and music in conversational applications, robustness to packet loss and delay jitter and backward compatibility to the AMR-WB codec.

At the decoder, the N_{dmx} channels are decoded by corresponding one or more instances of core codecs included in core decoding unit 758 and the side information including the AGC metadata is decoded by quantization and entropy decoding unit 754. A primary downmix channel, such as the W channel in an FOA signal format, is fed to decorrelator unit 761 which generates N−N_{dmx} decorrelated channels. The N_{dmx} downmix channels and AGC metadata are fed to inverse gain control block 763 which undoes the gain adjustment done by gain control unit 762. The inverse gain adjusted N_{dmx} downmix channels, N−N_{dmx} decorrelated channels and side information are fed to spatial synthesis/rendering unit 759 which uses these inputs to synthesize or regenerate the original N-channel input audio signal, which may be presented by audio devices 760. In an embodiment, N_{dmx} channels are decoded by mono codecs other than EVS. In other embodiments, N_{dmx} channels are decoded by a combination of one or more multi-channel core coding units and one or more single channel core coding units.

In some implementations, the FOA codec may allocate, or distribute, bits used for gain control between bits used to encode spatial metadata, e.g., utilized to reconstruct parametrically encoded channels, such as the PR, C, and P parameters in SPAR, and bits used to encode the downmixed channels. In general, the number of bits used to encode the metadata is generally referred to herein as MD_{bits}, and the bits used to encode the downmixed channels is generally referred to herein as EVS_{bits}, where EVS is the perceptual codec used to encode the downmixed channels. It should be noted that although the examples given below refer to use of the EVS codec as the codec, the techniques described below may be applied to any other suitable codec. In some implementations, the FOA codec may allocate the bits used for gain control by: 1) determining the number of bits used to encode the gain information; 2) determining a number of bits used to encode the metadata (e.g., determining MD_{bits}); 3) determining a number of bits used to encode the downmixed channels (e.g., determining EVS_{bits}); and 4) allocating the gain control bits from the metadata bits and/or the EVS_{bits} such that fewer bits are used to encode the metadata and/or the downmixed channels relative to instances in which no gain control is applied (and therefore, gain control information is not encoded).

FIG. 8 is a flowchart of an example process 800 for allocating gain control bits in accordance with some implementations. In some implementations, process 800 may be performed by an encoder device. In some implementations, blocks of process 800 may be performed in an order other than what is shown in FIG. 8. In some implementations, two or more blocks of process 800 may be performed substantially in parallel. In some implementations, one or more blocks of process 800 may be omitted.

At 802, process 800 may determine a number of bits to be used for encoding gain control information. The number of bits used to encode a gain parameter is generally represented herein as x. As described above in connection with FIG. 5, in some implementations, in instances in which a common gain transition function is applied to all downmix channels, the number of bits used to encode gain control information may be represented as x+1, where x bits are used to encode the gain parameter information, and where a single bit is used to indicate the transition function. Alternatively, as described above in connection with FIG. 5, in instances in which gain transition functions are separately applied to each downmix channel for which an overload condition exists, the number of bits used to encode gain control information may depend on the number of downmix channels (e.g., N_{dmx}), and the number of downmix channels N for which an overload condition exists (and therefore, for which gain control is applied). In such instances, the number of bits used to encode gain control information may be represented by Nit x+(x+1)*N, where a single bit is used for each downmix channel to indicate whether gain control has been applied, and where an exception flag is utilized for each downmix channel for which gain control has been applied to indicate the transition function. It should be noted that, in instances in which the number of downmix channels is 1 (e.g., a single W channel is utilized), the number of bits used for encoding gain control information may be represented as 1+(x+1)*N.

At 804, process 800 may determine a number of bits to be used for encoding metadata information, such as metadata that may be used by a decoder to reconstruct parametrically encoded channels, generally referred to herein as MD_{bits}. In some implementations, MD_{bits} may be determined such that MD_{bits} is a value between a target number of bits to be used to encode metadata (generally referred to herein as MDₜₐᵣ) and a maximum number of bits that may be used to encode metadata (generally referred to herein as MD max). In some implementations, MDₜₐᵣ may be determined based on a target number of bits to be used to encode the downmix channels (generally referred to herein as EVSₜₐᵣ), and MDₘₐₓ may be determined based on a minimum number of bits to be used to encode the downmix channels (generally referred to herein as EVSₘᵢₙ). In one example:

MDₜₐᵣ=IVAS_{bits}−header_{bits}−EVSₜₐᵣ

MDₘₐₓ=IVAS_{bits}−header_{bits}−EVSₘᵢₙ

In the above, IVAS_{bits} represents a number of bits available to encode information associated with the IVAS codec, and header_{bits} represents a number of bits used to encode a bitstream header. In some implementations, MD_{bits} may be less than or equal to MDₘₐₓ. In other words, the number of bits used to encode the metadata may be a number of bits that allows the downmix channels to be encoded with a sufficient number of bits to preserve audio quality.

In some implementations, MD_{bits} may be determined using an iterative process. An example of such an iterative process is as follows:

Step 1: on a per-frame basis of the input audio signals, metadata parameters may be quantized, e.g., in a non-time differential manner, and coded, e.g., using an arithmetic coder. If the number of bits MD_{bits} is less than the target number of metadata bits (e.g., MDₜₐᵣ), the iterative process may exit, and the metadata bits may be encoded into the bitstream. Any extra bits (e.g., MDₜₐᵣ−MD_{bits}) may be utilized by the core encoder, e.g., the EVS codec, to encode the downmix channels, thereby increasing the bitrate of the encoded downmix audio channels. If MD_{bits} is greater than the target number of bits, the iterative process may proceed to Step 2.

Step 2: A subset of metadata parameters associated with the frame may be quantized and subtracted from the quantized metadata parameter values of the previous frame, and the differential quantized parameter values may be encoded (e.g., using time differential coding). If the updated value of MD_{bits} is less than MDₜₐᵣ, the iterative process may exit, and the metadata bits may be encoded into the bitstream. Any extra bits (e.g., MDₜₐᵣ−MD_{bits}) may be utilized by the core encoder, e.g., the EVS codec. If MD_{bits} is greater than the target number of bits, the iterative process may proceed to Step 3.

Step 3: MD_{bits} may be determined when quantizing the metadata parameters without entropy. The values of MD_{bits} from steps 1, 2 and 3 are compared to the maximum number of bits that may be used to encode the metadata (e.g., MDₘₐₓ). If the minimum value of MD_{bits} from Steps 1, 2, and 3 is less than MDₘₐₓ, the iterative process exits, and the metadata may be encoded into the bitstream using the minimum value of MD_{bits} Bits used to encode the metadata that exceed the target number of metadata bits (e.g., MD_{bits}−MDₜₐᵣ) may be allocated from the bits to be used to encode the downmix channels. However, if, at step 3, the minimum value of MD_{bits} from steps 1, 2, and 3 exceeds MDₘₐₓ, the iterative process proceeds to Step 4:

Step 4: the metadata parameters may be quantized more coarsely, and the number of bits associated with the more coarsely quantized parameters may be analyzed according to steps 1-3 above. If even the more coarsely quantized metadata parameters do not satisfy the criteria that the number of metadata bits MD_{bits} is less than the maximum allocated number of bits for encoding metadata, a quantization scheme that guarantees quantization of the metadata parameters within the maximum allocated number of bits is utilized.

Referring back to FIG. 8, at block 806, process 800 can determine a number of bits used for encoding the downmix channels, generally referred to herein as EVS_{bits}. As described above in connection with block 804, in some implementations, the number of bits to be used for encoding the downmix channels may depend on the number of bits used to encode the metadata. For example, in instances in which fewer bits are used to encode the metadata parameters, more bits may be used to encode the downmix channels. Conversely, in instances in which more bits are used to encode the metadata parameters, fewer bits may be used to encode the downmix channels. In one example, EVS_{bits} may be determined by:

EVS_{bits}=/VAS_{bits}−header_{bits}−MD_{bits}

In some implementations, if the number of bits available to encode the downmix channels (e.g., EVS_{bits}) is less than a target number of bits to be used to encode the downmix channels (generally referred to herein as EVSₜₐᵣ), bits may be reallocated across the different downmix channels. In some implementations, bits may be reallocated from channels based on acoustic salience or acoustic importance. For example, in some implementations, bits may be taken from channels in the order of Z′, X′, Y′, and W′, because audio signals corresponding to the up-down direction, e.g., the Z′ channel, may be less acoustically relevant than other directions, e.g., the front-back, or X′ channel, or the left-right, or Y′ channel.

Conversely, in some implementations, if the number of bits available to encode the downmix channels (e.g., EVS_{bits}) is greater than the target number of bits EVSₜₐᵣ, the additional bits may be distributed to the downmix channels. In some implementations, distribution of the additional bits may be according to the various downmix channels acoustic importance. In one example, the additional bits may be distributed in the order of W′, Y′, X′, and Z′ such that additional bits are preferentially allocated to the omnidirectional channel.

At 808, process 800 may determine a bit allocation between the gain control bits, the metadata bits, and/or the downmix channel bits. In other words, process 800 may determine a number of bits to reduce the metadata bits (e.g., MD_{bits}) and/or the downmix channel bits (e.g., EVS_{bits}) by in order to encode the gain control information using the number of gain control bits determined in block 802.

In some implementations, process 800 may allocate bits used to encode the downmix channels to encode the gain control information. For example, in some implementations, process 800 may reduce EVS_{bits} by the number of bits to be used to encode the gain control information. In some such implementations, bits used to encode the downmix channels may be allocated to encode gain control information in an order based on acoustic importance or relevance of the downmix channels. In one example, bits may be taken from the downmix channels in the order of Z′, X′, Y′, and W′. In some implementations, the maximum number of bits that can be utilized from a single downmix channel may correspond to the difference between the target number of bits to be used to encode that downmix channel and the minimum number of bits to be used to encode that channel. In some implementations, if there are no available bits, from the bits allocated to encode the downmix channels, to encode the gain control information, process 800 may adjust a bitrate, e.g., reduce a bitrate, of one or more downmix channels to free up bits to encode gain control information. In one example, if, for all downmix channels, EVS_{bits} is set at the minimum number of bits to be used to encode that downmix channel, process 800 may reduce the bitrate. Alternatively, in some implementations, process 800 may allocate bits to encode the gain control information from bits to be used to encode the metadata parameters.

It should be noted that, in some implementations, process 800 may allocate bits to be used to encode the gain control information using both bits allocated to encode the downmix channels and bits allocated to encode the metadata parameters. For example, in some implementations, given AGC_{bits} needed to encode the gain control information, process 800 may allocate m bits from the bits originally allocated to encode the metadata parameters, e.g., as determined in block 804, and AGC_{bits}-m bits from the bits originally allocated to encode the downmix channels, e.g., as determined in block 806.

Process 800 can then proceed to the next frame of the input audio signal.

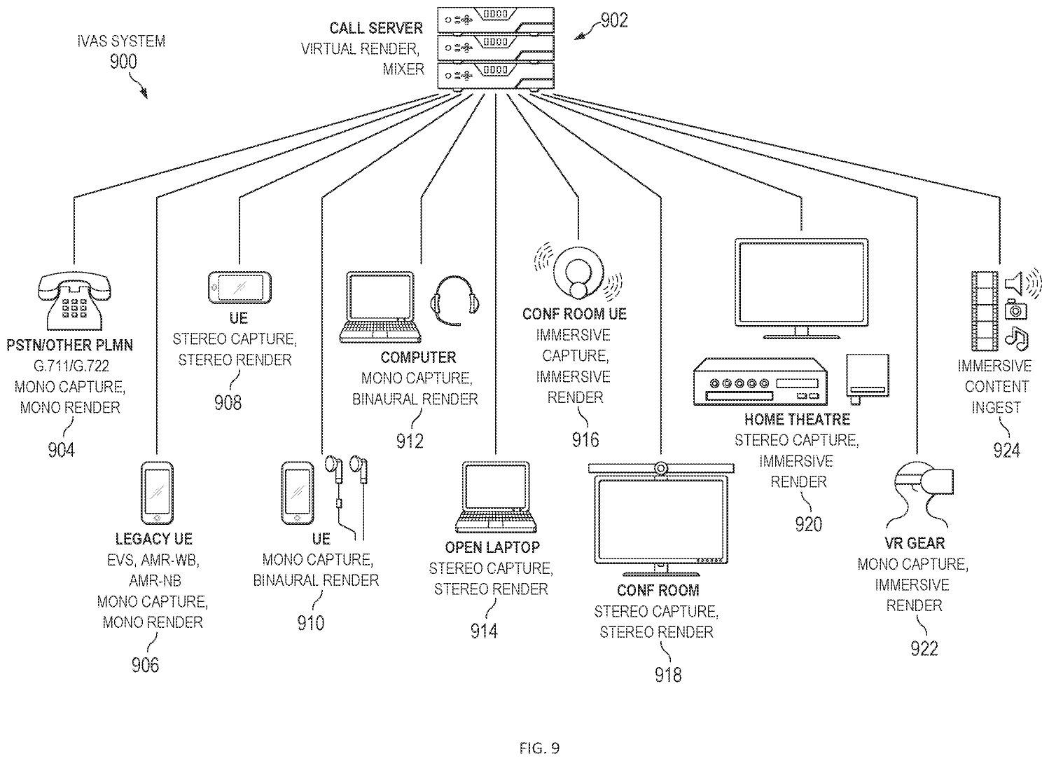

FIG. 9 illustrates example use cases for an IVAS system 900, according to an embodiment. In some embodiments, various devices communicate through call server 902 that is configured to receive audio signals from, for example, a public switched telephone network (PSTN) or a public land mobile network device (PLMN) illustrated by PSTN/OTHER PLMN 904. Use cases support legacy devices 906 that render and capture audio in mono only, including but not limited to: devices that support enhanced voice services (EVS), multi-rate wideband (AMR-WB) and adaptive multi-rate narrowband (AMR-NB). Use cases also support user equipment (UE) 908 and/or 914 that captures and renders stereo audio signals, or UE 910 that captures and binaurally renders mono signals into multi-channel signals. Use cases also support immersive and stereo signals captured and rendered by video conference room systems 916 and/or 918, respectively. Use cases also support stereo capture and immersive rendering of stereo audio signals for home theatre systems 920, and computer 912 for mono capture and immersive rendering of audio signals for virtual reality (VR) gear 922 and immersive content ingest 924.

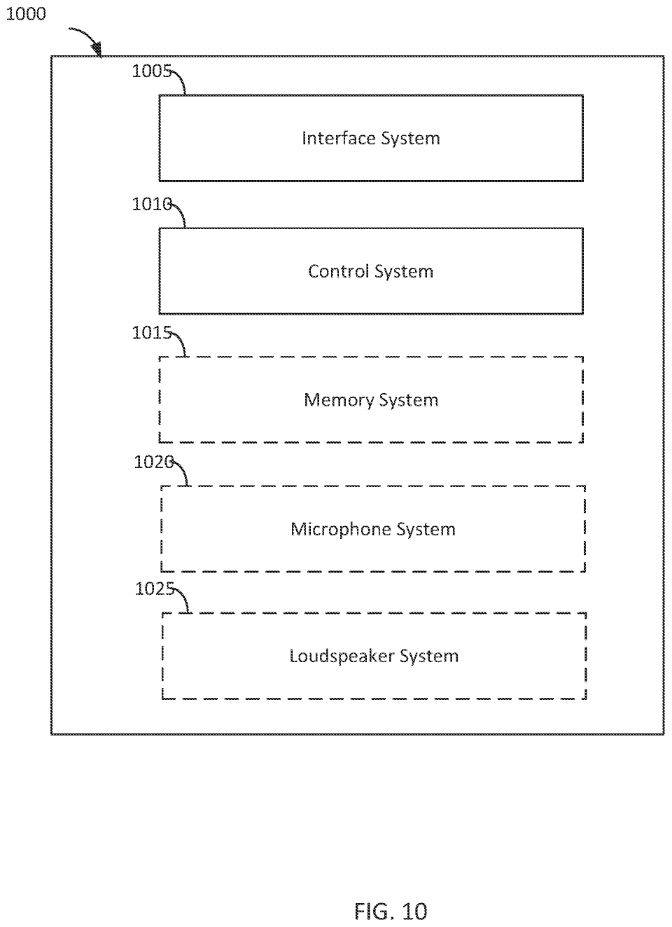

FIG. 10 is a block diagram that shows examples of components of an apparatus capable of implementing various aspects of this disclosure. As with other figures provided herein, the types and numbers of elements shown in FIG. 10 are merely provided by way of example. Other implementations may include more, fewer and/or different types and numbers of elements. According to some examples, the apparatus 1000 may be configured for performing at least some of the methods disclosed herein. In some implementations, the apparatus 1000 may be, or may include, a television, one or more components of an audio system, a mobile device (such as a cellular telephone), a laptop computer, a tablet device, a smart speaker, or another type of device.

According to some alternative implementations the apparatus 1000 may be, or may include, a server. In some such examples, the apparatus 1000 may be, or may include, an encoder. Accordingly, in some instances the apparatus 1000 may be a device that is configured for use within an audio environment, such as a home audio environment, whereas in other instances the apparatus 1000 may be a device that is configured for use in “the cloud,” e.g., a server.

In this example, the apparatus 1000 includes an interface system 1005 and a control system 1010. The interface system 1005 may, in some implementations, be configured for communication with one or more other devices of an audio environment. The audio environment may, in some examples, be a home audio environment. In other examples, the audio environment may be another type of environment, such as an office environment, an automobile environment, a train environment, a street or sidewalk environment, a park environment, etc. The interface system 1005 may, in some implementations, be configured for exchanging control information and associated data with audio devices of the audio environment. The control information and associated data may, in some examples, pertain to one or more software applications that the apparatus 1000 is executing.

The interface system 1005 may, in some implementations, be configured for receiving, or for providing, a content stream. The content stream may include audio data. The audio data may include, but may not be limited to, audio signals. In some instances, the audio data may include spatial data, such as channel data and/or spatial metadata. In some examples, the content stream may include video data and audio data corresponding to the video data.

The interface system 1005 may include one or more network interfaces and/or one or more external device interfaces, such as one or more universal serial bus (USB) interfaces. According to some implementations, the interface system 1005 may include one or more wireless interfaces. The interface system 1005 may include one or more devices for implementing a user interface, such as one or more microphones, one or more speakers, a display system, a touch sensor system and/or a gesture sensor system. In some examples, the interface system 1005 may include one or more interfaces between the control system 1010 and a memory system, such as the optional memory system 1015 shown in FIG. 10. However, the control system 1010 may include a memory system in some instances. The interface system 1005 may, in some implementations, be configured for receiving input from one or more microphones in an environment.

The control system 1010 may, for example, include a general purpose single- or multi-chip processor, a digital signal processor (DSP), an application specific integrated circuit (ASIC), a field programmable gate array (FPGA) or other programmable logic device, discrete gate or transistor logic, and/or discrete hardware components.

In some implementations, the control system 1010 may reside in more than one device. For example, in some implementations a portion of the control system 1010 may reside in a device within one of the environments depicted herein and another portion of the control system 1010 may reside in a device that is outside the environment, such as a server, a mobile device (e.g., a smartphone or a tablet computer), etc. In other examples, a portion of the control system 1010 may reside in a device within one environment and another portion of the control system 1010 may reside in one or more other devices of the environment. For example, a portion of the control system 1010 may reside in a device that is implementing a cloud-based service, such as a server, and another portion of the control system 1010 may reside in another device that is implementing the cloud-based service, such as another server, a memory device, etc. The interface system 1005 also may, in some examples, reside in more than one device.

In some implementations, the control system 1010 may be configured for performing, at least in part, the methods disclosed herein. According to some examples, the control system 1010 may be configured for implementing methods of determining gain parameters, applying gain transition functions, determining inverse gain transition functions, applying inverse gain transition functions, distributing bits for gain control with respect to a bitstream, or the like.

Some or all of the methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. The one or more non-transitory media may, for example, reside in the optional memory system 1015 shown in FIG. 10 and/or in the control system 1010. Accordingly, various innovative aspects of the subject matter described in this disclosure can be implemented in one or more non-transitory media having software stored thereon. The software may, for example, include instructions for determining gain parameters, applying gain transition functions, determining inverse gain transition functions, applying inverse gain transition functions, distribution bits for gain control with respect to a bitstream, etc. The software may, for example, be executable by one or more components of a control system such as the control system 1010 of FIG. 10.

In some examples, the apparatus 1000 may include the optional microphone system 1020 shown in FIG. 10. The optional microphone system 1020 may include one or more microphones. In some implementations, one or more of the microphones may be part of, or associated with, another device, such as a speaker of the speaker system, a smart audio device, etc. In some examples, the apparatus 1000 may not include a microphone system 1020. However, in some such implementations the apparatus 1000 may nonetheless be configured to receive microphone data for one or more microphones in an audio environment via the interface system 1010. In some such implementations, a cloud-based implementation of the apparatus 1000 may be configured to receive microphone data, or a noise metric corresponding at least in part to the microphone data, from one or more microphones in an audio environment via the interface system 1010.

According to some implementations, the apparatus 1000 may include the optional loudspeaker system 1025 shown in FIG. 10. The optional loudspeaker system 1025 may include one or more loudspeakers, which also may be referred to herein as “speakers” or, more generally, as “audio reproduction transducers.” In some examples, e.g., cloud-based implementations, the apparatus 1000 may not include a loudspeaker system 1025. In some implementations, the apparatus 1000 may include headphones. Headphones may be connected or coupled to the apparatus 1000 via a headphone jack or via a wireless connection, e.g., BLUETOOTH.

Some aspects of present disclosure include a system or device configured, e.g., programmed, to perform one or more examples of the disclosed methods, and a tangible computer readable medium, e.g., a disc, which stores code for implementing one or more examples of the disclosed methods or steps thereof. For example, some disclosed systems can be or include a programmable general purpose processor, digital signal processor, or microprocessor, programmed with software or firmware and/or otherwise configured to perform any of a variety of operations on data, including an embodiment of disclosed methods or steps thereof. Such a general purpose processor may be or include a computer system including an input device, a memory, and a processing subsystem that is programmed (and/or otherwise configured) to perform one or more examples of the disclosed methods (or steps thereof) in response to data asserted thereto.

Some embodiments may be implemented as a configurable (e.g., programmable) digital signal processor (DSP) that is configured (e.g., programmed and otherwise configured) to perform required processing on audio signal(s), including performance of one or more examples of the disclosed methods. Alternatively, embodiments of the disclosed systems (or elements thereof) may be implemented as a general purpose processor, e.g., a personal computer (PC) or other computer system or microprocessor, which may include an input device and a memory, which is programmed with software or firmware and/or otherwise configured to perform any of a variety of operations including one or more examples of the disclosed methods. Alternatively, elements of some embodiments of the inventive system are implemented as a general purpose processor or DSP configured (e.g., programmed) to perform one or more examples of the disclosed methods, and the system also includes other elements The other elements may include one or more loudspeakers and/or one or more microphones. A general purpose processor configured to perform one or more examples of the disclosed methods may be coupled to an input device. Examples of input devices include, e.g., a mouse and/or a keyboard. The general purpose processor may be coupled to a memory, a display device, etc.

Another aspect of present disclosure is a computer readable medium, such as a disc or other tangible storage medium, which stores code for performing, e.g., by a coder executable to perform, one or more examples of the disclosed methods or steps thereof.

While specific embodiments of the present disclosure and applications of the disclosure have been described herein, it will be apparent to those of ordinary skill in the art that many variations on the embodiments and applications described herein are possible without departing from the scope of the disclosure described and claimed herein. It should be understood that while certain forms of the disclosure have been shown and described, the disclosure is not to be limited to the specific embodiments described and shown or the specific methods described.

1-30. (canceled)

31. A method for performing gain control on audio signals, the method comprising:
determining downmixed signals associated with one or more downmix channels associated with a current frame of an audio signal to be encoded;
determining whether an overload condition exists for an encoder to be used to encode the downmixed signals for at least one of the one or more downmix channels;
responsive to determining that the overload condition exists, determining a gain parameter for the at least one of the one or more downmix channels for the current frame of the audio signal;
determining at least one gain transition function based on the gain parameter and a gain parameter associated with a preceding frame of the audio signal;
applying the at least one gain transition function to one or more of the downmixed signals; and
encoding the downmixed signals with the at least one gain transition function applied in connection with information indicative of gain control applied to the current frame;
wherein the at least one gain transition function comprises a transitory portion and a steady-state portion, and wherein the transitory portion corresponds to a transition from the gain parameter associated with the preceding frame of the audio signal to the gain parameter associated with the current frame of the audio signal; and wherein a duration of the transitory portion relates to a delay introduced by a codec comprising the encoder.

32. The method of claim 31, wherein the at least one gain transition function is determined using a partial frame buffer.

33. The method of claim 32, wherein determining the at least one gain transition function using the partial frame buffer introduces substantially 0 additional delay.

34. The method of claim 31, wherein the transitory portion has a transitory type of fade in which gain increases over a portion of samples of the current frame responsive to an attenuation associated with the gain parameter of the preceding frame being greater than an attenuation associated with the gain parameter of the current frame.

35. The method of claim 31, wherein the transitory portion has a transitory type of reverse fade in which gain decreases over a portion of samples of the current frame responsive to an attenuation associated with the gain parameter of the preceding frame being less than an attenuation associated with the gain parameter of the current frame.

36. The method of claim 31, wherein the transitory portion is determined using a prototype function and a scaling factor, and wherein the scaling factor is determined based on the gain parameter associated with the current frame and the gain parameter associated with the preceding frame.

37. The method of claim 31, wherein the information indicative of the gain control applied to the current frame comprises information indicative of the transitory portion of the at least one gain transition function.

38. The method of claim 31, wherein the at least one gain transition function comprises a single gain transition function applied to all of the one or more downmix channels for which the overload condition exists.

39. The method of claim 31, wherein the at least one gain transition function comprises a single gain transition function applied to all of the one or more downmix channels, and wherein the overload condition exists for a subset of the one or more downmix channels.

40. The method of claim 31, wherein the at least one gain transition function comprises a gain transition function for each of the one or more downmix channels for which the overload condition exists.

41. The method of claim 39, wherein a number of bits used to encode the information indicative of the gain control applied to the current frame scales substantially linearly, with a number of downmix channels for which the overload condition exists.

42. The method of claim 31, further comprising:
determining second downmixed signals associated with the one or more downmix channels associated with a second frame of the audio signal to be encoded;
determining whether an overload condition exists for the encoder for at least one of the one or more downmix channels for the second frame; and
responsive to determining that the overload condition does not exist for the second frame, encoding the second downmixed signals without applying a non-unity gain.

43. The method of claim 42, further comprising setting a flag indicating that gain control is not applied to the second frame, wherein the flag comprises one bit.

44. The method of claim 31, further comprising:
determining a number of bits used to encode the information indicative of the gain control applied to the current frame; and
allocating the number of bits from: 1) bits used to encode metadata associated with the current frame; and/or 2) bits used to encode the downmixed signals for encoding of the information indicative of the gain control applied to the current frame.

45. The method of claim 44, wherein the number of bits are allocated from bits used to encode the downmixed signals, and wherein the bits used to encode the downmixed signals are decreased in an order based on spatial directions associated with the one or more downmixed channels.

47. An apparatus configured for implementing the method of claim 31.

48. One or more non-transitory media having software stored thereon, the software including instructions for controlling one or more devices to perform the method of claim 31.
